(19) United States
(12) Patent Application Publication
(10) Pub. No.: US 2024/0235606 A1
(43) Pub. Date: Jul. 11, 2024

(54) SYSTEMS AND METHODS OF HEADER INFORMATION ELEMENT FOR UWB DATA COMMUNICATION

(71) Applicant: Meta Platforms Technologies, LLC, Menlo Park, CA (US)

(72) Inventors: Carlos Horacio Aldana, Mountain View, CA (US); Kangjin Yoon, Menlo Park, CA (US); Chunyu Hu, Saratoga, CA (US)

(73) Assignee: Meta Platforms Technologies, LLC, Menlo Park, CA (US)

(21) Appl. No.: 18/397,479

(22) Filed: Dec. 27, 2023

Related U.S. Application Data
(60) Provisional application No. 63/437,223, filed on Jan. 5, 2023.

(51) Int. Cl. H04B 1/7163; H04W 72/1263

(52) U.S. Cl. CPC H04B 1/7163; H04W 72/1263

(57) ABSTRACT

Systems and methods of header information element for UWB data communication may include a first device which generates a header information element (IE) for a data communication. The header IE may have a header type selected from a condensed header IE and a full header IE. The first device may transmit the header IE to a second device.

### CROSS-REFERENCE TO RELATED PATENT APPLICATIONS

This application claims the benefit of and priority to U.S. Provisional Patent Application No. 63/437,223, filed Jan. 5, 2023, the contents of which are incorporated by reference in their entirety.

### FIELD OF DISCLOSURE

The present disclosure is generally related to ultra-wideband devices, including but not limited to systems and methods for header information element(s) for ultra-wideband data communications.

### BACKGROUND

Ultra-wideband (UWB) technology provides for precise ranging between two devices having UWB devices or transceivers. Some devices may include UWB sensors as well as antennas/systems for supporting other types of wireless transmission technology outside of UWB (e.g., out-of-band), such as Wi-Fi, cellular, Bluetooth, etc. Some devices may use UWB for other applications, such as data communication, multi-millisecond ranging, time difference of arrival (TDoA), or sensing.

### SUMMARY

In one aspect, this disclosure is directed to a method. The method may include generating, by a first ultra-wideband (UWB) device, a header information element (IE) for a data communication, the header IE having a header type selected from a condensed header IE and a full header IE. The method may include transmitting, by the first UWB device, the header IE to a second UWB device.

In some embodiments, the method includes determining, by the first UWB device, a data size of the data communication. The method may include selecting, by the first UWB device, the type of header IE for the data communication according to the data size. In some embodiments, selecting the type of header IE for the data communication includes selecting, by the first UWB device, the header type according to a comparison of the data size of the data communication to a threshold. In some embodiments, the first UWB device selects the condensed header IE responsive to the data size being less than the threshold.

In some embodiments, the condensed header IE has fewer bits than the full header IE. In some embodiments, the full header IE includes a block duration field indicating a number of ranging rounds and a round duration field, and wherein the condensed header field includes a block duration field indicating a number of slots and omits a round duration field. In some embodiments, transmitting the header IE to the second UWB device includes transmitting, by the first UWB device, at a start of a ranging block, the header IE to the second wireless communication device. In some embodiments, the condensed header IE includes a scheduling list length field and a scheduling list type field. In some embodiments, the scheduling list type field has a value selected from a first value indicating a per-slot scheduling with a slot index, a second value indicating a per-slot scheduling without a slot index, a third value indicating a bitmap-based scheduling, and a fourth value indicating a periodic scheduling.

In another aspect, this disclosure is directed to a first device. The first device may include an ultra-wideband (UWB) transceiver and one or more processors configured to generate a header information element (IE) for a data communication, the header IE having a header type selected from a condensed header IE and a full header IE. The one or more processors may be configured to transmit, via the UWB transceiver, the header IE to a second device.

In some embodiments, the one or more processors are configured to determine a data size of the data communications and can select the type of header IE for the data communication according to the data size. In some embodiments, the one or more processors are configured to select the header type according to a comparison of the data size of the data communication to a threshold. In some embodiments, the one or more processors select the condensed header IE responsive to the data size being less than the threshold.

In some embodiments, the condensed header IE has fewer bits than the full header IE. In some embodiments, the full header IE includes a block duration field indicating a number of ranging rounds and a round duration field, and wherein the condensed header field can include a block duration field indicating a number of slots and can omit a round duration field. In some embodiments, the one or more processors are configured to transmit, at a start of a ranging block, the header IE to the second wireless communication device. In some embodiments, the condensed header IE includes a scheduling list length field and a scheduling list type field. In some embodiments, the scheduling list type field has a value selected from a first value indicating a per-slot scheduling with a slot index, a second value indicating a per-slot scheduling without a slot index, a third value indicating a bitmap-based scheduling, and/or a fourth value indicating a periodic scheduling.

In another aspect, this disclosure is directed to a wireless communication device including an ultra-wideband (UWB) transceiver configured to generate a header information element (IE) for a data communication, the header IE having a header type selected from a condensed header IE and a full header IE. The UWB transceiver may be configured to transmit the header IE to a second device.

In some embodiments, the UWB transceiver is configured to determine a data size of the data communication, compare the data size to a threshold, and can select the type of header IE for the data communication according to the comparison. The UWB transceiver may select the condensed header IE responsive to the data size being less than the threshold.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of an artificial reality environment, according to an example implementation of the present disclosure.

FIG. 4 is a block diagram of another artificial reality environment, according to an example implementation of the present disclosure.

FIG. 5 is a block diagram of another artificial reality environment, according to an example implementation of the present disclosure.

FIG. 6 is a block diagram of a computing environment, according to an example implementation of the present disclosure.

FIG. 7 is a block diagram of a system for slot scheduling, according to an example implementation of the present disclosure.

FIG. 8 is a diagram of an information element (IE) (e.g., generated by the system of FIG. 7), according to an example implementation of the present disclosure.

FIG. 9 is a diagram of an example scheduling list element (e.g., of the IE of FIG. 8), according to an example implementation of the present disclosure.

FIG. 10A-FIG. 10C are diagrams of example scheduling list fields (e.g., of the scheduling list element of FIG. 9), according to example implementations of the present disclosure.

FIG. 11 is a flowchart showing an example method of slot scheduling, according to an example implementation of the present disclosure.

FIG. 12 is a block diagram of a system for ultra-wideband in-band discovery, according to an example implementation of the present disclosure.

FIG. 13 is a diagram showing an example frame structure of an application control information element (AC IE) sent by a controller of the system of FIG. 12, according to an example implementation of the present disclosure.

FIG. 14 is a diagram showing a first example round of slots of the controller including the AC IE, according to an example implementation of the present disclosure.

FIG. 15 is a diagram showing an example frame structure of an association request sent by a controlee of the system of FIG. 12, according to an example implementation of the present disclosure.

FIG. 16 is a diagram showing a second example round of slots of the controller including the association request sent by the controlee, according to an example implementation of the present disclosure.

FIG. 17 is a diagram showing an example frame structure of an association response sent by the controller to the controlee, according to an example implementation of the present disclosure.

FIG. 18 is a diagram showing a third example round of slots of the controller including the association response sent by the controller, according to an example implementation of the present disclosure.

FIG. 19 is a flowchart showing an example method for ultra-wideband in-band discovery, according to an example implementation of the present disclosure.

FIG. 20 is a block diagram of a system for communicating compressed header information elements, according to an example implementation of the present disclosure.

FIG. 21 is a diagram showing an example frame structure of a condensed header information element of FIG. 20.

FIG. 22 is a flowchart showing an example method of communicating compressed header information elements, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are embodiments related to devices operating in the ultra-wideband (UWB) spectrum. In various embodiments, UWB devices (including pucks, anchors, UWB beacons, UWB antennas, etc.) operate in the 3-10 GHz unlicensed spectrum using 500+ MHz channels which may require low power for transmission. For example, the transmit power spectral density (PSD) for some devices may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices within a shared or common environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and low to moderate rate data communication. For example, employing UWB devices as described herein allows for a determination of a relative location between two or more UWB devices with precision (e.g., determination of devices within 5-10 degrees of rotation and a distance within 0.5 mm). The determination of the location, position, tilt, and/or rotation of UWB devices relative to one another enables, among other features, clear spatial audio content to be communicated between the UWB devices (and/or between multiple other devices such as a first device and any peripheral devices). Spatial audio, in some aspects, refers to three-dimensional audio, where three-dimensional audio describes the phenomenon/situation of audio emanating from (or appearing to emanate from) various locations. In some embodiments, the audio signal may seem to originate within objects. In contrast to spatial content, head-locked content refers to content that is fixed with respect to a user. For example, a user wearing a head wearable device (HWD) configured with spatial audio capabilities may experience audio behind the user, in front of the user, above the user, to the side of the user, below the user, and so on. In contrast, a user wearing a HWD configured with head-locked rotation may experience a fixed audio sound emanating from a fixed location, regardless of the user's rotation/movement in an environment.

In some embodiments, sensors (e.g., inertial measurement units, magnetometers, cameras, etc.) can provide head locked rotation data corresponding to the movement and/or orientation of the sensors or an associated object. However, such collected sensor data may be affected by signal drift. Moreover, the collected sensor data may be limited in its ability to provide/maintain accurate positions in space. Additionally, the collected sensor data may be limited in its capacity to describe the distance of objects relative to position and rotations relative to other objects. In some embodiments, sensor data may be used in conjunction with such techniques as virtual reality simultaneous localization and mapping (VR SLAM) and object detection to enable spatial audio content to be communicated. However, utilizing a sensor such as a camera to facilitate spatial audio content implies that the camera would always be on, consuming excessive power and utilizing real estate on a limited space device (e.g., a head wearable device).

As UWB employs relatively simple modulation, it may be implemented at low cost and low power consumption. Accordingly, UWB devices may be employed to track movement and/or orientation so as to support, process and/or communicate spatial audio content. In AR/VR applications, link budget calculations for an AR/VR controller link indicate that the systems and methods described herein may be configured for effective data throughput ranging from ˜2 to 31 Mbps (e.g., with 31 Mbps being the maximum possible rate in the latest 802.15.4z standard), which may depend on body loss assumptions. Using conservative body loss assumptions, the systems and methods described herein should be configured for data throughput of up to approximately 5 Mbps, which may be sufficient to meet the data throughput performance standards for AR/VR links. With a customized implementation, data throughput rate could be increased beyond 27 Mbps (e.g., to 54 Mbps), but with a possible loss in link margin.

Using UWB allows one or more devices to determine their relative distance to one another. The determination of a relative distance from a device can be used to anchor a user in a digital/physical/audio environment. Accordingly, spatial audio content can be output from a known source location (e.g., an audio source) and be received by a user coupled to a device based on the position/orientation of the user coupled to the device and the audio source. In some embodiments, sensors (such as IMUs and magnetometers) may collect data in conjunction with data collected from UWB devices to achieve a high sample rate relative to the determined location and/or rotation. Various applications, use cases, and further implementations of the systems and methods described herein are described in greater detail below.

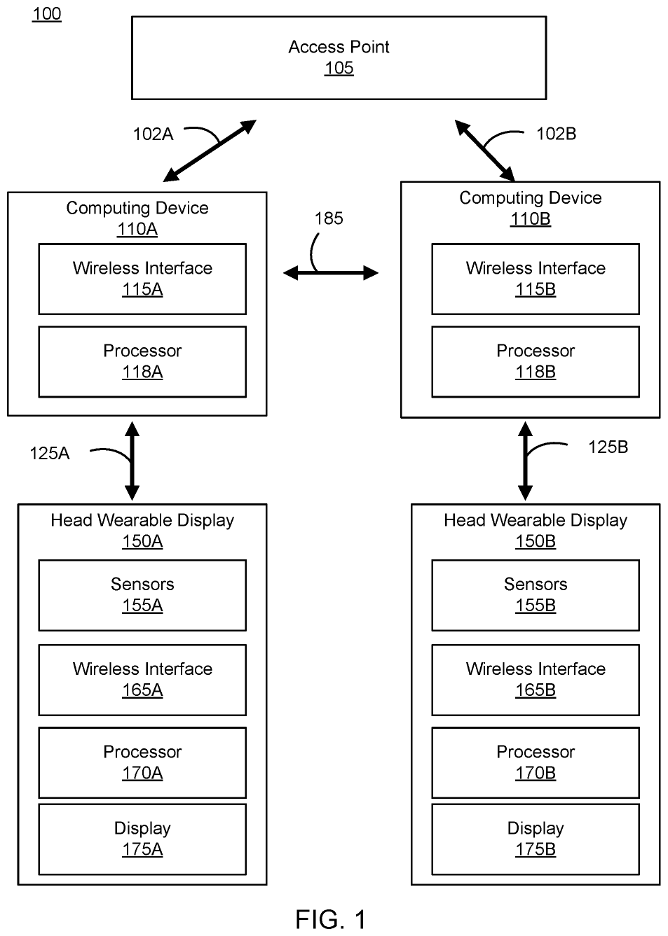

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as devices or consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

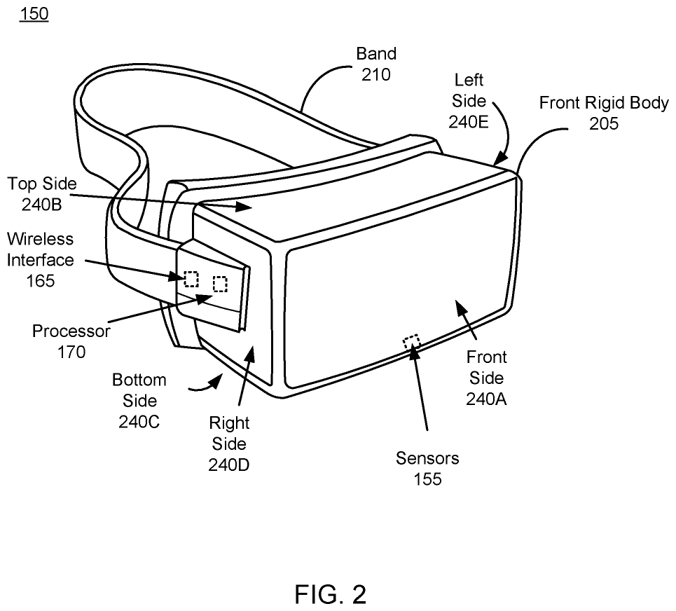

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

In various embodiments, the devices in the environments described above may operate or otherwise use components which leverage communications in the ultra-wideband (UWB) spectrum. In various embodiments, UWB devices operate in the 3-10 GHz unlicensed spectrum using 500+ MHz channels which may require low power for transmission. For example, the transmit power spectral density (PSD) for some systems may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices located in the environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and for low-to-moderate rate data communication. As UWB employs relatively simple modulation, it may be implemented at low cost and low power consumption. In AR/VR applications (or in other applications and use cases), link budget calculations for an AR/VR controller link indicate that the systems and methods described herein may be configured for effective data throughput ranging from ˜2 to 31 Mbps (e.g., with 31 Mbps being the maximum possible rate in the latest 802.15.4z standard), which may depend on body loss assumptions

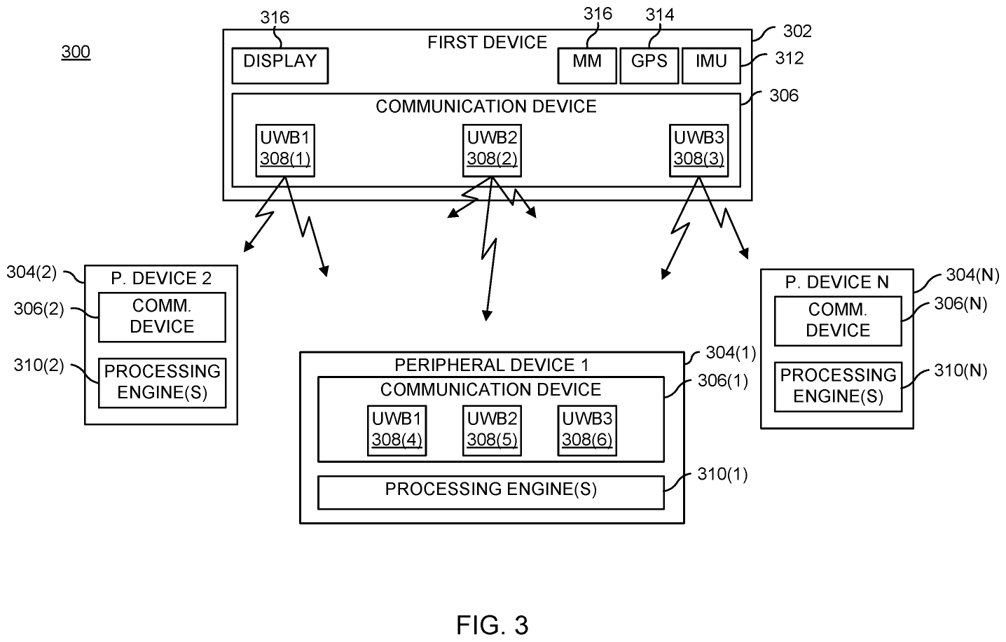

Referring now to FIG. 3, depicted is a block diagram of an artificial reality environment 300. The artificial reality environment 300 is shown to include a first device 302 and one or more peripheral devices 304(1)-304(N) (also referred to as “peripheral device 304,” “second device 304,” or “device 304”). The first device 302 and peripheral device(s) 304 may each include a communication device 306 including a plurality of UWB devices 308. A set of UWB devices 308 may be spatially positioned/located (e.g., spaced out) relative to each other on different locations on/in the first device 302 or the peripheral device 304, so as to maximize UWB coverage and/or to enhance/enable specific functionalities. The UWB devices 308 may be or include antennas, sensors, or other devices and components designed or implemented to transmit and receive data or signals in the UWB spectrum (e.g., between 3.1 GHz and 10.6 GHz) and/or using UWB communication protocol. In some embodiments, one or more of the devices 302, 304 may include various processing engines 310. The processing engines 310 may be or include any device, component, machine, or other combination of hardware and software designed or implemented to control the devices 302, 304 based on UWB signals transmitted and/or received by the respective UWB devices 308.

As noted above, the environment 300 may include a first device 302. The first device 302 may be or include a wearable device, such as the HWD 150 described above, a smart watch, AR glasses, or the like. In some embodiments, the first device 302 may include a mobile device (e.g., a smart phone, tablet, console device, or other computing device). The first device 302 may be communicably coupled with various other devices 304 located in the environment 300. For example, the first device 302 may be communicably coupled to one or more of the peripheral devices 304 located in the environment 300. The peripheral devices 304 may be or include the computing device 110 described above, a device similar to the first device 302 (e.g., a HWD 150, a smart watch, mobile device, etc.), an automobile or other vehicle, a beacon transmitting device located in the environment 300, a smart home device (e.g., a smart television, a digital assistant device, a smart speaker, etc.), a smart tag configured for positioning on various devices, etc. In some embodiments, the first device 302 may be associated with a first entity or user and the peripheral devices 304 may be associated with a second entity or user (e.g., a separate member of a household, or a person/entity unrelated to the first entity).

In some embodiments, the first device 302 may be communicably coupled with the peripheral device(s) 304 following a pairing or handshaking process. For example, the first device 302 may be configured to exchange handshake packet(s) with the peripheral device(s) 304, to pair (e.g., establish a specific or dedicated connection or link between) the first device 302 and the peripheral device 304. The handshake packet(s) may be exchanged via the UWB devices 308, or via another wireless link 125 (such as one or more of the wireless links 125 described above). Following pairing, the first device 302 and peripheral device(s) 304 may be configured to transmit, receive, or otherwise exchange UWB data or UWB signals using the respective UWB devices 308 on the first device 302 and/or peripheral device 304. In some embodiments, the first device 302 may be configured to establish a communications link with a peripheral device 304 (e.g., without any device pairing). For example, the first device 302 may be configured to detect, monitor, and/or identify peripheral devices 304 located in the environment using UWB signals received from the peripheral devices 304 within a certain distance of the first device 302, by identifying peripheral devices 304 which are connected to a shared Wi-Fi network (e.g., the same Wi-Fi network to which the first device 302 is connected), etc. In these and other embodiments, the first device 302 may be configured to transmit, send, receive, or otherwise exchange UWB data or signals with the peripheral device 304.

In some embodiments, the first device 302 may recognize one or more peripheral devices 304 and initiate a communication link. For example, the first device 302 may be preconfigured with peripheral devices 304 identified as reliable, safe, etc.

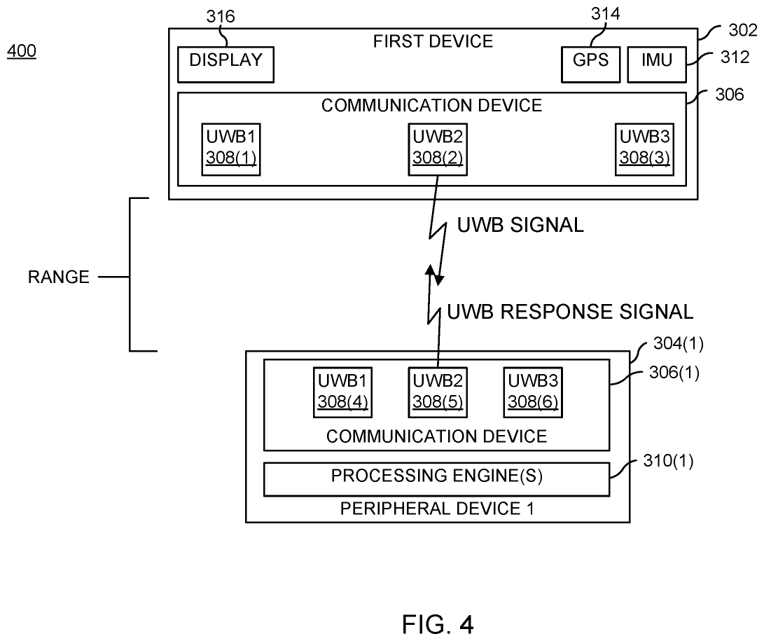

Referring now to FIG. 4, depicted is a block diagram of an environment 400 including the first device 302 and a peripheral device 304. The first device 302 and/or the peripheral device 304 may be configured to determine a range (e.g., a spatial distance, separation) between the devices 302, 304. The first device 302 may be configured to send, broadcast, or otherwise transmit a UWB signal (e.g., a challenge signal). The first device 302 may transmit the UWB signal using one of the UWB devices 308 of the communication device 306 on the first device 302. The UWB device 308 may transmit the UWB signal in the UWB spectrum. The UWB signal may have a high bandwidth (e.g., 500 MHZ). As such, the UWB device 308 may be configured to transmit the UWB signal in the UWB spectrum (e.g., between 3.1 GHz and 10.6 GHz) and having a high bandwidth (e.g., 500 MHZ). The UWB signal from the first device 302 may be detectable by other devices within a certain range of the first device 302 (e.g., devices having a line of sight (LOS) within 200 m of the first device 302). As such, the UWB signal may be more accurate for detecting range between devices than other types of signals or ranging technology.

The peripheral device 304 may be configured to receive or otherwise detect the UWB signal from the first device 302. The peripheral device 304 may be configured to receive the UWB signal from the first device 302 via one of the UWB devices 308 on the peripheral device 304. The peripheral device 304 may be configured to broadcast, send, or otherwise transmit a UWB response signal responsive to detecting the UWB signal from the first device 302. The peripheral device 304 may be configured to transmit the UWB response signal using one of the UWB devices 308 of the communication device 306 on the peripheral device 304. The UWB response signal may be similar to the UWB signal sent from the first device 302.

The first device 302 may be configured to detect, compute, calculate, or otherwise determine a time of flight (TOF) based on the UWB signal and the UWB response signal. The TOF may be a time or duration between a time in which a signal (e.g., the UWB signal) is transmitted by the first device 302 and a time in which the signal is received by the peripheral device 304. The first device 302 and/or the peripheral device 304 may be configured to determine the TOF based on timestamps corresponding to the UWB signal. For example, the first device 302 and/or peripheral device 304 may be configured to exchange transmit and receive timestamps based on when the first device 302 transmits the UWB signal (a first TX timestamp), when the peripheral device receives the UWB signal (e.g., a first RX timestamp), when the peripheral device sends the UWB response signal (e.g., a second TX timestamp), and when the first device 302 receives the UWB response signal (e.g., a second RX timestamp). The first device 302 and/or the peripheral device 304 may be configured to determine the TOF based on a first time in which the first device 302 sent the UWB signal and a second time in which the first device 302 received the UWB response signal (e.g., from the peripheral device 304), as indicated by first and second TX and RX timestamps identified above. The first device 302 may be configured to determine or calculate the TOF between the first device 302 and the peripheral device 304 based on a difference between the first time and the second time (e.g., divided by two).

In some embodiments, the first device 302 may be configured to determine the range (or distance) between the first device 302 and the peripheral device 304 based on the TOF. For example, the first device 302 may be configured to compute the range or distance between the first device 302 and the peripheral device 304 by multiplying the TOF and the speed of light (e.g., TOF×c). In some embodiments, the peripheral device 304 (or another device in the environment 400) may be configured to compute the range or distance between the first device 302 and peripheral device 304. For example, the first device 302 may be configured to transmit, send, or otherwise provide the TOF to the peripheral device 304 (or other device), and the peripheral device 304 (or other device) may be configured to compute the range between the first device 302 and peripheral device 304 based on the TOF, as described above.

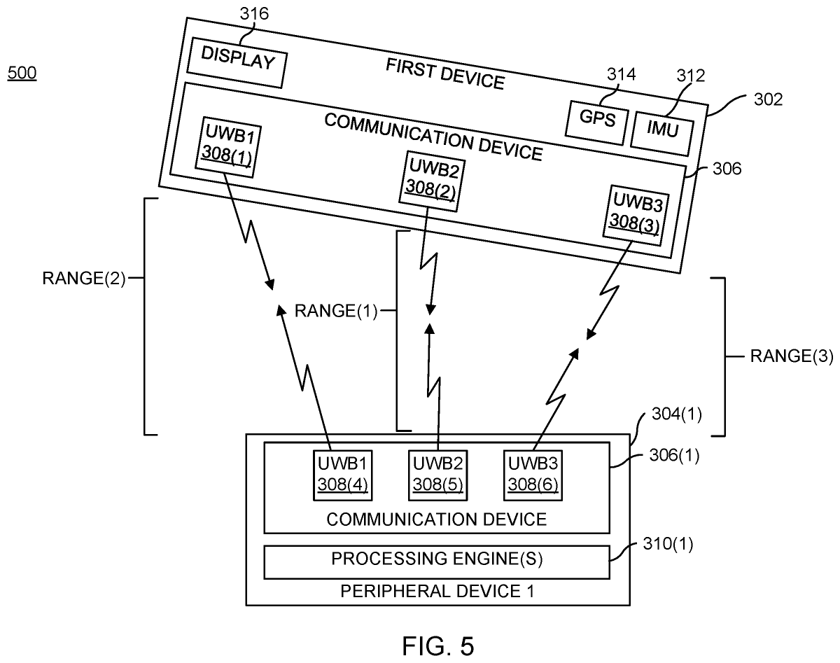

Referring now to FIG. 5, depicted is a block diagram of an environment 500 including the first device 302 and a peripheral device 304. In some embodiments, the first device 302 and/or the peripheral device 304 may be configured to determine a position or pose (e.g., orientation) of the first device 302 relative to the peripheral device 304. The first device 302 and/or the peripheral device 304 may be configured to determine the relative position or orientation in a manner similar to determining the range as described above. For example, the first device 302 and/or the peripheral device 304 may be configured to determine a plurality of ranges (e.g., range(1), range(2), and range(3)) between the respective UWB devices 308 of the first device 302 and the peripheral device 304. In the environment 500 of FIG. 5, the first device 302 is positioned or oriented at an angle relative to the peripheral device 304. The first device 302 may be configured to compute the first range (range(1)) between central UWB devices 308(2), 308(5) of the first and peripheral device 304. The first range may be an absolute range or distance between the devices 302, 304, and may be computed as described above with respect to FIG. 4.

The first device 302 and/or the peripheral device 304 may be configured to compute the second range(2) and third range(3) similar to computing the range(1), In some embodiments, the first device 302 and/or the peripheral device 304 may be configured to determine additional ranges, such as a range between UWB device 308(1) of the first device 302 and UWB device 308(5) of the peripheral device 304, a range between UWB device 308(2) of the first device 302 and UWB device 308(6) of the peripheral device 304, and so forth. While described above as determining a range based on additional UWB signals, it is noted that, in some embodiments, the first device 302 and/or the peripheral device 304 may be configured to determine a phase difference between a UWB signal received at a first UWB device 308 and a second UWB device 308 (i.e., the same UWB signal received at separate UWB devices 308 on the same device 302, 304). The first device 302 and/or the peripheral device 304 may be configured to use each or a subset of the computed ranges (or phase differences) to determine the pose, position, orientation, etc. of the first device 302 relative to the peripheral device 304. Determining the pose, position, orientation, etc. of the first device 302 relative to the peripheral device 304 based on phase differences between UWB signals at the first device 302 and peripheral device 304 may be considered determining the post, position, orientation, etc. according to an angles of arrival (AoA). For example, the first device and/or the peripheral device 304 may be configured to use one of the ranges relative to the first range(1) (or phase differences) to determine a yaw of the first device 302 relative to the peripheral device 304, another one of the ranges relative to the first range(1) (or phase differences) to determine a pitch of the first device 302 relative to the peripheral device 304, another one of the ranges relative to the first range(1) (or phase differences) to determine a roll of the first device 302 relative to the peripheral device 304, and so forth.

By using the UWB devices 308 at the first device 302 and peripheral devices 304, the range and pose may be determined with greater accuracy than other ranging/wireless link technologies. For example, the range may be determined within a granularity or range of +/−0.1 meters, and the pose/orientation may be determined within a granularity or range of +/−5 degrees.

Referring to FIG. 3-FIG. 5, in some embodiments, the first device 302 may include various sensors and/or sensing systems. For example, the first device 302 may include an inertial measurement unit (IMU) sensor 312, global positioning system (GPS) 314, magnetometer (MM) 316, etc. The sensors and/or sensing systems, such as the IMU sensor 312, MM 316, and/or GPS 314 may be configured to generate data corresponding to the first device 302. For example, the IMU sensor 312 may be configured to generate data corresponding to an absolute position and/or pose of the first device 302. Similarly, the GPS 314 may be configured to generate data corresponding to an absolute location/position of the first device 302. Further, the MM 316 may be configured to measure magnetic fields and/or magnetic dipoles. The data from the IMU sensor 312, MM 316 and/or GPS 314 may be used in conjunction with the ranging/position data determined via the UWB devices 308 as described above. For example, collecting IMU 312 data and MM 316 data, in addition to UWB data, may allow the first device 302 to achieve a high sample rate relative to the first device 302 location and/or rotation.

In some embodiments, the first device 302 may include a display 316. The display 316 may be integrated or otherwise incorporated in the first device 302. In some embodiments, the display 316 may be separate or remote from the first device 302. The display 316 may be configured to display, render, or otherwise provide visual information to a user or wearer of the first device 302, which may be rendered at least in part on the ranging/position data of the first device 302.

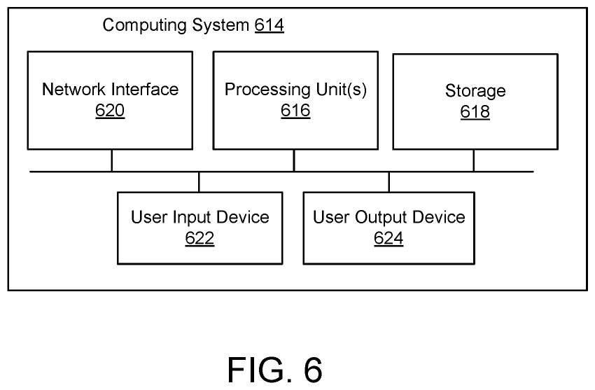

Various operations described herein can be implemented on computer systems. FIG. 6 shows a block diagram of a representative computing system 614 usable to implement the present disclosure. In some embodiments, the computing device 110, the HWD 150, devices 302, 304, or each of the components of FIG. 1-5 are implemented by or may otherwise include one or more components of the computing system 614. Computing system 614 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 614 can be implemented to provide VR, AR, MR experience. In some embodiments, the computing system 614 can include conventional computer components such as processors 616, storage device 618, network interface 620, user input device 622, and user output device 624.

Network interface 620 can provide a connection to a wide area network (e.g., the Internet) to which WAN interface of a remote server system is also connected. Network interface 620 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 622 can include any device (or devices) via which a user can provide signals to computing system 614; computing system 614 can interpret the signals as indicative of particular user requests or information. User input device 622 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 624 can include any device via which computing system 614 can provide information to a user. For example, user output device 624 can include a display to display images generated by or delivered to computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 624 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 616 can provide various functionality for computing system 614, including any of the functionality described herein as being performed by a server or client, or other functionality associated with message management services.

It will be appreciated that computing system 614 is illustrative and that variations and modifications are possible. Computer systems used in connection with the present disclosure can have other capabilities not specifically described here. Further, while computing system 614 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

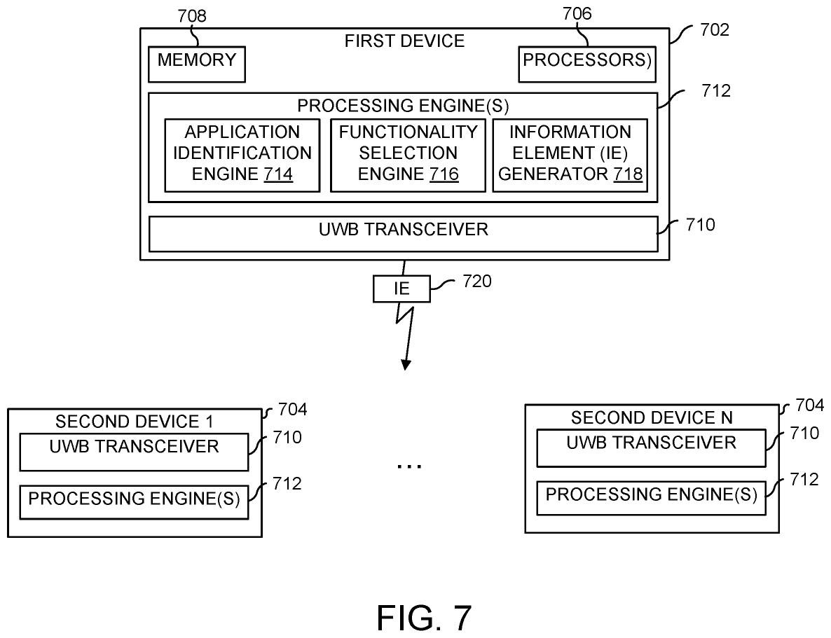

Referring generally to FIG. 7 through FIG. 11, various embodiments described herein are related to systems and methods for slot scheduling for various ultra-wideband (UWB) applications or functionalities. As described above, UWB may support various functionalities in addition to ranging, such as (but not limited to) sensing, data communication, time difference of arrival (TDoA), and the like. In various instances, such functionalities may use multiple slots within a time window for transmissions. For example, to transmit data, a UWB device may use multiple slots within a time window to transmit portions of the data to another UWB device. Similarly, where the UWB device supports sensing, the UWB device may use multiple slots within a time window to transmit sensing measurements to another UWB device.

According to the systems and methods described herein, a first ultra-wideband (UWB) device may determine a number of slots to be used for a session between the first UWB device and a second UWB device. The first device may generate an information element (IE) including one or more scheduling list elements indicating the number of slots. The first UWB device may transmit the IE to the second device, to establish the session according to the number of slots indicated by the IE. In various embodiments, the scheduling list element may be specific to a particular functionality (e.g., each functionality to be used or supported during the session may include a respective scheduling list element). Such implementations may provide for scheduling for each functionality to be used during the session, without having separate information elements generated for each functionality.

Referring now to FIG. 7, depicted is a block diagram of a system 700 for slot scheduling, according to an example implementation of the present disclosure. The system 700 may include a first device 702 and any number second devices 704 (referred to generally as a second device 704). The first device 702 may be similar to the first device 302 and the second device 704 may be similar to the peripheral device(s) 304, described above with reference to FIG. 3-FIG. 5. The first device 702 (and second device 704) may include one or more processors 706 and memory 708, which may be similar, respectively, to the processor(s) 118/170 or processing units 616 and storage 618 described above with reference to FIG. 1-FIG. 6. The first device 702 and second device 704 may include respective ultra-wideband (UWB) transceivers 710 and processing engine(s) 712. The UWB transceivers 710 may be similar to the communication device(s) 306, 310 and the processing engine(s) 712 may be similar to the processing engine(s) 310, described above with reference to FIG. 3-FIG. 5.

As described in greater detail below, the first device 702 may be configured to generate/establish an information element (IE) for transmission (in a message) to the second device(s) 704. The IE may schedule slots for various functionalities for UWB transmissions between the first device 702 and second device(s) 704. The IE may include, for each functionality configured by the IE, corresponding scheduling list elements which define, set, or otherwise establish slot scheduling for the respective functionality. The first device 702 may be configured to transmit, send, communicate, or otherwise provide the IE to the second device 704.

The first device 702 and second device 704 may support various UWB functionalities/tasks/functions for communication during a UWB session between the devices 702, 704. The UWB functionalities may be or include functions which are performed using/via UWB signals or transmissions exchanged between the respective UWB transceivers 710. For example, the first device 702 and second device 704 may support a ranging functionality, a sensing functionality, a data communication functionality, a time difference of arrival (TDoA) functionality, and so forth. The ranging functionality may include a UWB function by which the first and second devices 702, 704 exchange various signals for determining a range (or distance) between the respective devices 702, 704. The sensing functionality may include a UWB function by which (for example) the first device 702 embeds, incorporates, or otherwise includes sensing measurements (e.g., from various sensor(s) 155 of the device 702) in UWB signals sent to the second device 704 (and/or vice versa). The data communication functionality may include a UWB function by which the first device 702 embeds, incorporates, or otherwise includes data or a payload in UWB signals sent to the second device 704 (and/or vice versa). The TDoA functionality may include a UWB function by which the first device 702 (or second device 704) measures or determines time differences between received signals from anchor UWB transceiver(s) for determining relative position/angular position relative to the anchor(s). In various embodiments, additional functionalities may be rolled out, provisioned, deployed, or otherwise provided to the first device 702 and second device 704. Such functionalities may be used to support various applications/resources of the devices 702, 704 during a session between the devices 702, 704.

The first device 702 may include an application identification engine 714. The application identification engine 714 may be or include any device, component, processor, circuitry, or hardware designed or configured to determine, detect, assess, or otherwise identify an application executing (or to be executed) on the first device 702. In some embodiments, the application identification engine 714 may be configured to identify an application selected by a user of the first device 702, for use during a session with the second device 704. For example, a user of the first device 702 may launch an application via the first device 702, and can initiate a session with the second device 704. The application may be or include any application, program, executable instructions, or resource which can be executed by the first device 702. In some embodiments, the first device 702 may establish sessions with multiple second devices 704, each supporting a different application for a respective session between the first device 702 and second devices 704. As described above, various applications or resources may use or leverage different UWB functionalities. For example, some applications may use a data communication functionality (e.g., a video calling application), some applications may support ranging and TDoA functionalities (e.g., an AR/VR application), and so forth.

The first device 702 may include a functionality selection engine 716. The application identification engine 716 may be or include any device, component, processor, circuitry, or hardware designed or configured to determine, detect, assess, or otherwise identify one or more functionalities to be used during the session between the first device 702 and second device 704. In some embodiments, the functionality selection engine 716 may be configured to determine one or more functionalities to be used for the identified application. In some embodiments, the functionality selection engine 716 may be configured to determine the functionalities based on or according to the application or application type. For example, the functionality selection engine 716 may be configured to use an application identifier for the application (or application type) (e.g., identified by the application identification engine 714) to perform a look-up in a data structure, to identify the corresponding functionalities which are used by the application. In some embodiments, the application may report, select, or otherwise identify the functionalities (e.g., to the functionality selection engine 716) at initialization/launch/start-up, etc.

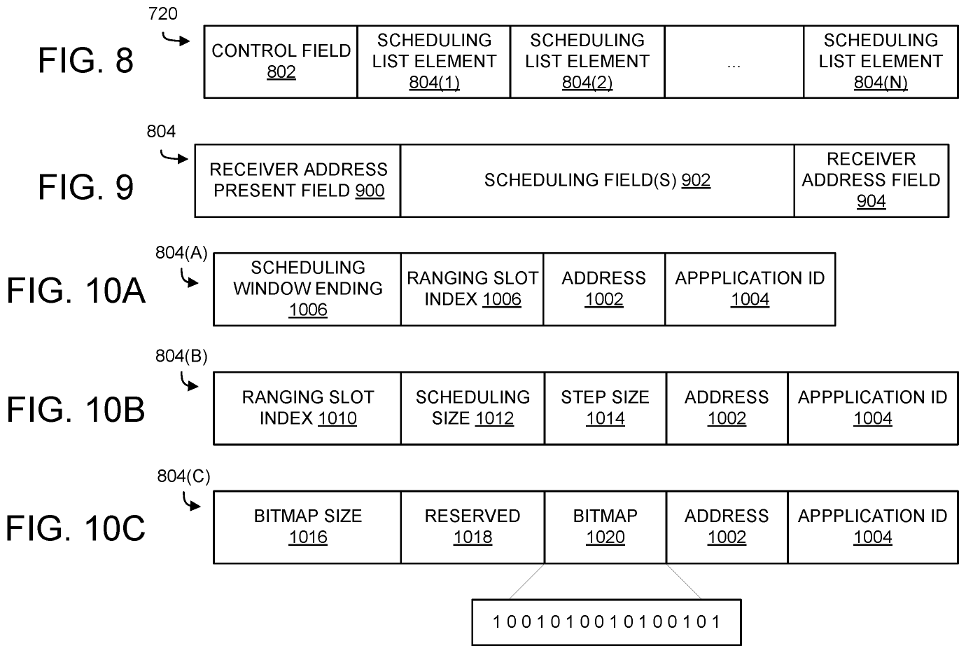

The first device 702 may include an information element (IE) generator 718. The IE generator 718 may be or include any device, component, processor, circuitry, or hardware designed or configured to establish, produce, create, or otherwise generate an IE 720 for transmission to the second device 704. The IE generator 718 may be configured to generate the IE 720, to configure or establish the session between the first device 702 and second device 704 (or sessions between the first device 702 and second devices 704). The IE generator 718 may be configured to generate the IE 720 according to each of the one or more functionalities identified or selected by the functionality selection engine 716. The IE generator 718 may be configured to generate the IE 720 to schedule various slots for the functionalities identified or selected by the functionality selection engine 716. Various example implementations of the IE 720 are described in greater detail below with reference to FIG. 8-FIG. 10C.

The first device 702 may be configured to communicate, transmit, send, or otherwise provide the IE 720 to the second device 704. In some embodiments, the first device 702 may be configured to provide the IE 720 to the second device 704 via the respective UWB transceivers 710. In this regard, the first device 702 may be configured to provide the IE 720 in-band (e.g., as a UWB signal according to a UWB protocol) to the second device 704. In some embodiments, the first device 702 may be configured to provide the IE 720 to the second device 704 out-of-band (e.g., via a Wi-Fi signal, a Bluetooth signal, or some other signal generated and sent according to a non-UWB protocol). For example, the first device 702 may be configured to transmit the IE 720 via a Wi-Fi connection to the second device 704, to configure the UWB session between the first device 702 and second device 704.

The second device 704 may be configured to receive the IE from the first device 704. Where multiple second devices 704 are in an environment and targets for establishing a session with the first device 702, each second device 704 may receive the IE from the first device 704. The second device(s) 704 may be configured to receive the IE via the UWB transceiver 710 (and/or via some other transceiver configured for communication via another protocol). The second device 704 may be configured to respond to the IE (e.g., to accept various configurations of the IE 720, to modify various configurations, etc.) as part of a handshake with the first device 702. The first and second device 702, 704 may be configured to establish the UWB session according to the IE 720 (and response). Once established, the first and second device(s) 702, 704 may be configured to communicate with one another according to the configurations of the IE 720. For example the first and second device 702, 704 may be configured to transmit various transmissions for a first functionality (e.g., ranging functionality) in a first set of slots for the session and transmissions for a second functionality (e.g., data communication functionality) in a second set of slots for the session, according to the IE 720. Similarly, the first device 702 may be configured to transmit various transmissions for a first functionality in a first set of slots for a session with one of the second devices 704, and may be configured to transmit various transmissions for a second functionality in a second set of slots for another session with another one of the second devices 704.

Referring now to FIG. 8, depicted is a diagram of the IE 720, according to an example implementation of the present disclosure. As described above, the IE generator 718 may be configured to generate the IE 720 for transmission to the second device 704. As shown in FIG. 8, the IE 720 may include a control field 802 and one or more scheduling list elements 804(1)-804(N) (referred to generally as a scheduling list element 804). The control field may be or include data, information, or other values for configuring various parameters of the IE 720, such as an address size, scheduling list length, and the like.

The IE generator 718 may be configured to generate the scheduling list element(s) 804, to define, set, configure, or otherwise schedule a number of slots and sequence of the slots transmissions between the devices 702, 704. The IE generator 718 may be configured to determine the number and sequence of slots according to, for example, the application or application type which is supported by the corresponding functionality. For instance, the application may request a particular frequency/cadence/periodicity/cadence in which a functionality is to be performed. The IE generator 718 may be configured to determine the number and sequence of slots based on the request from the application. For example, the application may request a particular data throughput (e.g., a data rate) for a data communication functionality. The IE generator 718 may be configured to determine the number of slots and sequence of slots, to provide the data throughput. As another example, an application may request a particular sensing frequency or periodicity. The IE generator 718 may be configured to determine the number of slots and sequence to achieve the requested sensing frequency/periodicity.

In some embodiments, the IE 720 may include a plurality of scheduling list elements 804. For instance, the IE 720 may include one or more scheduling list elements 804 for each functionality which is to be used in the session. For example, the IE 720 may include a first scheduling list element 804 (or a first set of scheduling list elements 804) for a ranging functionality, a second scheduling list element 804 for a data communication functionality, a third scheduling list element 804 for a TDoA functionality, and so forth. The IE generator 718 may be configured to generate the scheduling list element(s) 804 of the IE 720, to schedule a number of slots and sequence of the slots for transmissions of the corresponding functionality during the session between the devices 702, 704.

Referring now to FIG. 9, depicted is an example scheduling list element 804 of the IE 720, according to an example implementation of the present disclosure. In some embodiments, the scheduling list element 804 may include a receive address present field 900, one or more scheduling fields 902, and/or a receiver address field 904. The receiver address present field 900 may be or include a field indicating a presence or absence of an address of the receiver of the IE 720 (e.g., in the receiver address field 904). The IE generator 718 may be configured to set the receiver address present field 900 (e.g., to high, or “1”) based on whether the IE generator 718 includes the address of the receiver in the field 904. The IE generator 718 may include the address of the receiver in the field 904 where, for example, multiple known devices are located in the same environment as the first and second devices 702, 704. On the other hand, the IE generator 718 may forego including the address of the receiver in the field 904 where there is a low likelihood of interference due to multiple devices being present. By including the receiver address in the field 904, a recipient of the IE 720 may identify the receiver address from the field 904 and determine if the recipient is the intended receiver (e.g., based on a match of an address of the recipient with the receiver address from the field 904). Where the recipient does not identify a match, the recipient may discard the IE 720 (or disregard the particular scheduling list element 804) and enter a sleep state (e.g., to conserve battery). While shown as being included in the scheduling list element 804 (e.g., at the start and end of the scheduling list element 804), it is noted that the receiver address present field 900 and receiver address field 904 may be located anywhere in the IE 702 (e.g., inside of and/or external to any scheduling list element 804).

Referring to FIG. 10A—FIG. 10C, depicted are various examples of scheduling list field(s) of a scheduling list element 804, according to an example implementation of the present disclosure. In particular, FIG. 10A depicts example scheduling list fields for a start and end scheduling list element 804(A), FIG. 10B depicts example scheduling list fields for a size and step scheduling list element 804(B), and FIG. 10C depicts example scheduling list fields for a bitmap scheduling list element 804(C), according to example implementations of the present disclosure. It is noted that, while the scheduling list fields of the scheduling list elements 902(A)-(C) are shown in a particular order, the present disclosure is not limited to the particular order shown. Rather, the scheduling list fields can be ordered or arranged in many different permutations or variations of those shown in FIG. 10A—FIG. 10C.

As shown in FIG. 10A—FIG. 10C, the scheduling list elements 804 may include an address 1002 and application identifier (ID) 1004. While shown as being included in each embodiment shown in FIG. 10A—FIG. 10C, it is noted that, in some embodiments, some scheduling list elements 804 may not include an address 1002 and/or an application ID 1004. The address 1002 may be or include an address of the receiver (e.g., similar to the receiver address field 904). The application identifier 1004 may be an identifier of the application/program/resource which is using the particular functionality corresponding to the scheduling list element 804. In this regard, the IE generator 718 may be configured to generate scheduling list elements 804 for individual devices, as well as for individual applications and functionalities, for various sessions. As such, the IE 720 may provide an adaptable and scalable configuration for various different use cases and environments.

Referring specifically to FIG. 10A, in some embodiments, the IE 720 may include start and end scheduling list elements 804(A). The scheduling list element 804(A) may include a plurality of scheduling list fields, including a schedule window ending field 1002, a ranging slot index field 1004. The schedule window ending field can denote whether the scheduling list element 804(A) is a starting scheduling list element 804(A) or an ending scheduling list element 804(A). For example, the IE 720 may include two (or more) scheduling list elements 804(A) for configuring a slot schedule for a functionality, where the first scheduling list element 804(A) identifies a start of the slot schedule and the second scheduling list element 804(A) identifies an end of the slot schedule. The schedule window ending field 1002 may be set according to the type of scheduling list element (e.g., “0” if starting scheduling list element and “1” of ending scheduling list element). The ranging slot index can denote/indicate/identify a slot which is the start (or end) of the slot schedule.

As a brief example, to schedule three slots for a particular functionality (e.g., ranging), the first device 702 may generate two scheduling list elements 804(A). The first scheduling list element 804(A) may have, among other values for the various fields, a schedule window ending field 1002 set to “0” and a ranging slot index 1004 set to “1”. The second scheduling list element 804(A) may have a scheduling window field 1002 set to “1” and a ranging index 1004 set to “3”. The first and second scheduling list elements 804(A) may therefore indicate, via two separate scheduling list elements 804(A), that the slots begin (e.g., by scheduling window ending field 1002 being set to “0”) at slot 1 and end (e.g., by scheduling window ending field 1002 for being set to “1”) at slot 3, thereby providing for three slots consecutive slots. The start and end scheduling list element 804(A) may be suitable for applications or instances in which a functionality uses several consecutive slots during a session.

Referring specifically to FIG. 10B, in some embodiments, the IE 720 may include size and step scheduling list element 804(B). The scheduling list element 804(B) can include a ranging slot index field 1010, a scheduling size field 1012, and a step size field 1014. The ranging slot index field 1010 can indicate/configure/select/identify a starting slot of the scheduled slots (e.g., similar to the ranging slot index 1006 of FIG. 10A). The scheduling size field 1012 can identify a number of slots to be scheduled for the session. The step size field 1014 can identify a number of slots to be skipped between scheduled slots. For example, to schedule two active slots over four total slots (starting at a first slot) with one slot skipped between scheduled active slots, the IE generator 718 may generate the scheduling list element 804(B) to include a ranging slot index 1010 set to “1” (e.g., identifying the first slot), a scheduling size field 1012 set to “4” (e.g., identifying four total slots), and a step size field 1014 set to “1” (e.g., identifying one slot to be skipped between scheduled active slots). Such a scheduling list element 804(B) provides a slot scheduling sequence of 1-0-1-0. The size and step scheduling list element 804(B) may be suitable for applications or instances in which functionality has a known periodic cadence (e.g., sensing at an N-interval, where N corresponds to the selected step size).

Referring specifically to FIG. 10C, in some embodiments, the IE 720 may include a bitmap scheduling list element 804(C). The scheduling list element 804(C) may include a bitmap size field 1016, a reserved field 1018 (which may be used for any field or purpose), and/or a bitmap field 1020. The bitmap size field 1016 can indicate a size of the bitmap field 1020 (e.g., total number of bits in the bitmap field 1020). The bitmap field 1020 can indicate a scheduling pattern, where each bit represents a slot. For example, to schedule an irregular slot scheduling pattern of five slots starting at the first slot separated by an alternating number of skipped slots (e.g., alternating between 1 and 2 skipped slots), the IE generator 718 may the scheduling list element 804(C) to include a bitmap size field 1016 set to “5” (e.g., to indicate 5 total bits in the bitmap field 1020), and a bitmap field 1020 of 10100. The bitmap scheduling list element 804(C) may provide the most flexibility in slot scheduling, by providing various different configurations for slots at irregular (e.g., non-repeating) cadences.

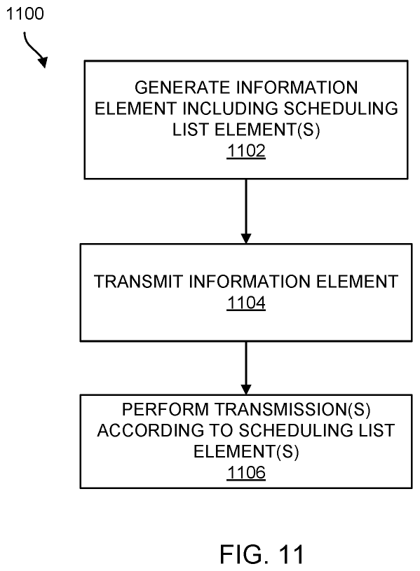

Referring now to FIG. 11, depicted is a flowchart showing an example method 1100 of slot scheduling, according to an example implementation of the present disclosure. As a brief overview, at step 1102, a first device may generate an information element including scheduling list elements. At step 1104, the first device may transmit the information element. At step 1106, the first device may perform transmissions according to the scheduling list elements.

At step 1102, a first device may generate an information element including scheduling list elements. In some embodiments, the first device may generate an information element (IE) for scheduling slots for one or more functionalities of a plurality of functionalities. The functionalities may be used by or supported by ultra-wideband (UWB) transmissions between the first device and a second device. The first device may be the first device 702 described above, the UWB transceiver 710 of the first device 702, etc. Similarly, the second device may be the second device 704, the UWB transceiver 710 of the second device 704, etc. The functionalities may be or include various functionalities which are used or supported by UWB transmissions. For example, the functionalities may include a ranging functionality, a data communication functionality, a sensing functionality, a time difference of arrival (TDoA) functionality, and any other functionality used or supported by UWB transmissions, whether now or in the future.

In some embodiments, the first device may generate the IE based on or according to one or more applications executing on the first device. For example, a user of the first device may request launching of an application on the first device, to establish a session with the second device. The first device may generate the IE responsive to receiving the request. The first device may generate the IE based on or according to a configuration of the first device (e.g., whether or not the first device supports a particular functionality) and targets for the application (e.g., a target frequency or cadence of data transmission, a target frequency or cadence of sensing, etc.).

The IE may include one or more scheduling list elements for each of the one or more functionalities (e.g., the one or more functionalities which are to use scheduled slots). In some embodiments, the IE may include scheduling list elements for each functionality and each application using the corresponding functionality. In other words, where two applications are using the same functionality concurrently, the first device may generate the IE to include a first scheduling list element for the functionality for the first application and a second scheduling list element for the functionality for the second application. The scheduling list elements may define slot scheduling for the respective functionality.

In some embodiments, the scheduling list element may include an address and an application identifier. The address may be an address of a receiver or recipient of the IE and corresponding to the scheduling list element. For example, the address may be an address of the second device which is the target for performing the functionality corresponding to the scheduling list element. In this regard, the first device may use a single IE to configure/set/establish/schedule slots for different functionalities across different devices and for different applications. The application identifier may be an identifier of an application/process/program/resource which is using the corresponding functionality during the session. For example, where an AR/VR application is requesting a TDoA functionality, the first device may include an identifier of the AR/VR application in the scheduling list element for the TDoA functionality for that particular AR/VR application.

The first device may configure/establish/generate the scheduling list element as one of the various types of scheduling list elements described herein. In some embodiments, the first device may generate the scheduling list element as a bitmap scheduling list element. The bitmap scheduling list element, as described above with reference to FIG. 10C, may include a bitmap size field and a bitmap field. The first device may generate the bitmap scheduling list element to include a bitmap size in the bitmap size field (e.g., to indicate a number of bits in the bitmap field). The first device may generate the bitmap scheduling list element to include a bitmap in the bitmap field. The bitmap may include a plurality of bits representing corresponding slots. For example, the bitmap may be 1010010001, where each bit represents a slot and the value for the bit indicates whether the bit is an active (or scheduled) slot (e.g., a value of high or “1” indicates a scheduled slot and a value of “0” indicates an inactive slot). In some embodiments, the first device may generate the scheduling list element as a start and stop scheduling list element. The start and stop scheduling list element, as described above with reference to FIG. 10A, may include a plurality of scheduling list elements for scheduling consecutive slots (e.g., a first scheduling list element and a second scheduling list element). The first scheduling list element and second scheduling list element may include a scheduling window ending field (e.g., indicating identification of a starting/ending slot) and a ranging slot index indicating an index of the starting/ending slot. In some embodiments, the first device may generate the scheduling list element as a size and step scheduling list element. The size and step scheduling list element, as described above with reference to FIG. 10C, may include a first field for indicating a starting slot, a second field for indicating a number of slots, and a third field for indicating a step size.

At step 1104, the first device may transmit the information element. In some embodiments, the first device may transmit the IE to the second device. The first device may transmit the IE responsive to generating the IE at step 1102. The first device may transmit the IE as part of establishing a session with the second IE. The first device may transmit the IE via an in-band signal (e.g., via a UWB signal using the respective UWB transceivers) or via an out-of-band signal (e.g., via a non-UWB signal using a different transceiver or the same transceiver in a different frequency outside of the UWB spectrum).

In some embodiments, the second device may receive the IE from the first device. The second device may receive the IE responsive to the first device transmitting the IE (e.g., via the in-band or out-of-band signal). The second device may generate a response to the IE. In some embodiments, the second device may generate the response as an acknowledgement to the IE. The acknowledgement may accept various fields of the IE, modify/update other fields of the IE, etc., as part of a negotiation/handshake procedure between the devices. The second device may transmit the response to the first device. The first device and the second device may establish a session (e.g., a UWB session) based on or according to the IE and response.

At step 1106, the first device may perform transmissions according to the scheduling list elements. In some embodiments, the first device may transmit various transmissions in corresponding scheduled slots, for the respective functionalities, to the second device. For example, assuming that the first device and second device established a session for transmitting UWB transmissions which support ranging and data communication functionalities for a particular application, the IE may include a first scheduling list element for the ranging functionality for the application and a second scheduling list element for the data communication functionality. Upon establishing the session, the first device may transmit a first set of transmissions corresponding to the first functionality (e.g., ranging functionality) according to the first scheduling list element, and transmit a second set of transmissions corresponding to the second functionality (e.g., data communication functionality) according to the second scheduling list element. In this regard, the first device may transmit the transmissions in the respective slots scheduled for the corresponding functionality.

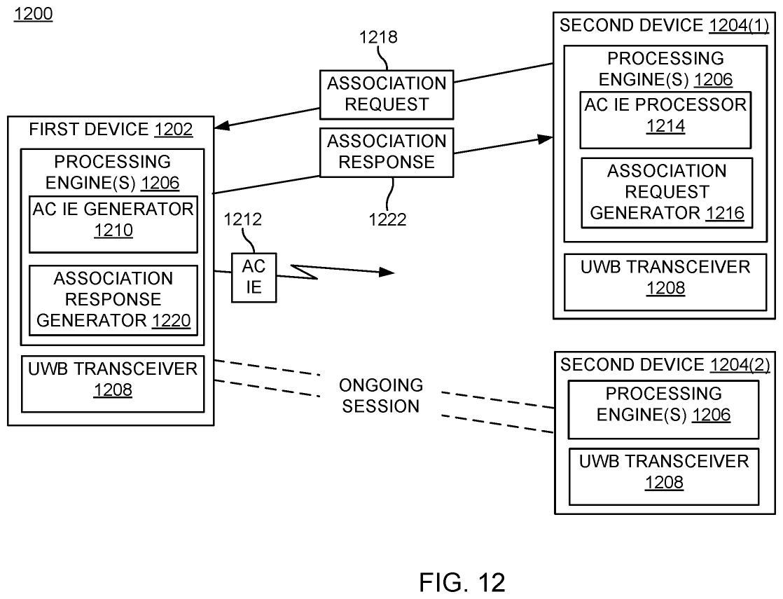

Referring to FIG. 12, depicted is a block diagram of a system 1200 for ultra-wideband in-band discovery, according to an example implementation of the present disclosure. The system 1200 may include a first device 1202 and one or more second devices 1204(1), 1204(2) (referred to generally as “second device 1204” or “second device(s) 1204”). The first device 1202 and second devices 1204 may be similar to the first device 302 and peripheral device(s) 304 described above with reference to FIG. 3 through FIG. 5. Each device 1202, 1204 may include respective processing engines 1206 and ultra-wideband (UWB) transceivers 1208. The processing engines 1206 may be similar to the processing engines 310 described above with reference to FIG. 3 through FIG. 5. The UWB transceivers 1208 may be similar to the communication device 306 including antenna(s) 308 described above with reference to FIG. 3 through FIG. 5. In some embodiments, the first device 1202 may be a controller device, and the second device(s) 1204 may be controlee devices.

In various instances, the first device 1202 may have ongoing session(s) with one or more second devices 1204, where such ongoing session(s) are established as described herein. Another second device 1204(1), e.g., upon switching to an active state, being powered on, and so forth, may attempt to establish a session with the first device 1202. The second device 1204(1) may be configured to discover the first device 1202, to establish the session with the first device 1202, using the in-band device discovery components, steps, and methods described herein. As described in greater detail below, the first device 1202 (e.g., controller device) may be configured to determine an availability for additional association(s) with controlee device(s). The first device 1202 may be configured to establish, generate, or otherwise configure an application control (AC) information element (IE) 1212 based on the availability for additional associations. The AC IE 1212 may be configured to signal (e.g., to controlee(s)) whether any additional associations are available with the first device 1202. The first device 1202 may be configured to broadcast, communicate, send, share, or otherwise transmit the AC IE 1212 (e.g., during a round). The second device 1204 may be configured to receive the AC IE 1212, and can generate an association request 1218 to establish the session with the first device 1202. The second device 1202 may be configured to transmit the association request 1218 in an available slot (e.g., of the round) to the first device 1202. Upon receiving the association request 1218, the first device 1202 may be configured to generate and transmit an association response to the second device 1204.

The first device 1202 and second device(s) 1204 may include one or more processing engines 1206. The processing engine(s) 1206 may be or include any device, component, element, or hardware designed or configured to perform various steps or functions as described herein. For example, the first device 1202 may include an AC IE generator 1210 and an association response generator 1220, and the second device(s) 1204 may include an AC IE processor 1214 and an association request generator 1216. While shown as including different processing engines 1206, it should be understood that, in various embodiments, the devices 1202, 1204 may each include instances of each of the processing engines described herein. For example, the first device 1202 may also include an AC IE processor 1214 and association request generator 1216, and the second device 1204 may include an AC IE generator 1210 and an association response generator 1220. As such, the present disclosure is not limited to the particular arrangement shown in FIG. 12, which is illustrated for purposes of demonstrating processing engines maintained by a controller device and a controlee device. Further, in various embodiments, while shown as separate processing engines 1206, in various embodiments, one or more of the processing engine(s) 1206 shown in FIG. 12 may be combined into a single processing engine, or a processing engine 1206 may be separated into multiple processing engines.

The first device 1202 may include an AC IE generator 1210. The AC IE generator 1210 may be or include any device, component, element, or hardware designed or configured to generate, establish, create, produce, or otherwise configure an AC IE 1212. The AC IE generator 1210 may be configured to determine an availability of associations with the first device 1202. In some embodiments, the AC IE generator 1210 may be configured to determine the availability based on currently used resources of the first device 1202. For example, the AC IE generator 1210 may be configured to determine the availability based on whether any sessions have been currently established, and the resources currently used by such sessions (e.g., number of slots assigned to a particular session during a given round, total bandwidth allocated to current sessions, currently used functionalities or capabilities of the first device 1202, etc.). The AC IE generator 1210 may be configured to determine that one or more additional associations with a potential controlee are available, responsive to the available resources satisfying one or more criterion (e.g., one or more available slots, for example). Conversely, the AC IE generator 1210 may be configured to determine that no further associations are available responsive to the available resources not satisfying the one or more criterion (e.g., no available slots).

Referring to FIG. 12 and FIG. 13, the AC IE generator 1210 may be configured to generate an AC IE 1212 having a frame format as shown in FIG. 13. Specifically, FIG. 13 is a diagram showing an example frame structure of a portion of an AC IE 1212, according to an example implementation of the present disclosure. The AC IE 1212 may include various fields for providing values corresponding to a content control of the AC IE 1212. In other words, the AC IE 1212 may include at least some of the fields shown in FIG. 13, as well as additional fields which are not shown (such as session identifier fields, block and round durations, slot durations, etc.) for purposes of brevity. As shown in FIG. 13, the AC IE 1212 may include a plurality of presence fields 1302-1308 indicating a presence of various corresponding fields in the AC IE 1212 (e.g., a session ID presence (SIP) field 1302 indicating a presence of a session ID in the AC IE 1212, a ranging block duration presence (RBDP) field 1304 indicating a presence of a ranging block duration in the AC IE 1212, a ranging round duration presence (RRDP) field 1306 indicating a presence of a ranging round duration in the AC IE 1212, and a ranging slot duration presence (RSDP) field 1308 indicating a presence of a ranging slot duration in the AC IE 1212). The AC IE 1212 may include additional field(s) 1314, including control presence fields for indicating whether control fields are present for various other functionalities or capabilities which may be used between devices 1202, 1204 as part of their respective sessions, such as ranging control fields, data communication control fields, sensing control fields, time difference of arrival (TDoA) control fields, and so forth. The AC IE 1212 may further include a reserved fields for various reserved bits.

The AC IE 1212 may include a scheduling mode field 1310 and an association availability field 1312. The scheduling mode field 1310 may be a field which indicates a type of scheduling to be used for the session. For example, the scheduling mode field 1310 may include a value indicating whether or not contention-based access is to be used. The association availability field 1312 may be a field which indicates whether the controller device (e.g., the first device 1202) is available for any additional association(s) with controlee device(s) (e.g., second device(s) 1204). The AC IE generator 1210 may be configured to set a value for the association availability field 1312 based on or according to the availability determined by the first device. For example, the AC IE generator 1210 may be configured to set the value for the association availability field 812 to high (or “1”) where the first device 1202 is available for additional association(s), and may be configured to set the value to low (or “0”) where the first device 1202 is not available for an additional association.

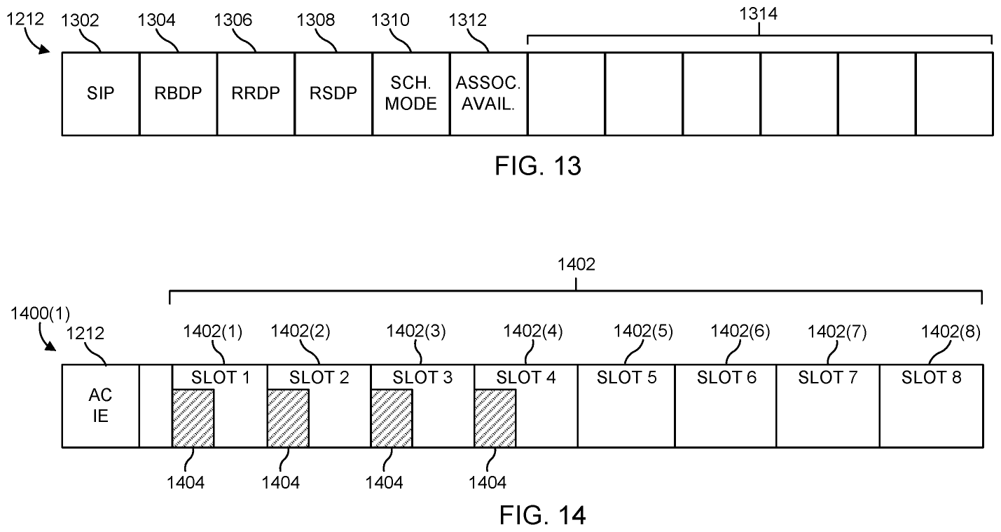

Referring now to FIG. 12 and FIG. 14, the first device 1202 may be configured to communicate, share, broadcast, or otherwise transmit the AC IE 1212 during a round (e.g., via the UWB transceiver 1208 of the first device 1202). Specifically, FIG. 14 shows an example of a first round 1400 of slots 1402 of the first device 1202 (e.g., with one or more second devices 1204). In the example shown in FIG. 14, the first device 1202 may be configured to transmit the AC IE 1212 at a start of the round 1400, prior to the start of the first slot 1402(1). By transmitting the AC IE 1212 via the UWB transceiver 1208, which indicates availability for association with one or more second devices 1204, and exchanging of association requests and responses occurring via respective UWB transceivers 1208 of the first device 1202 and second device(s) 1204, the association and session(s) may be established “in-band”, as opposed to being out-of-band through some other wireless communication technology (such as BLUETOOTH).

As shown in FIG. 14, the round 1400 may include a plurality of slots 1402, some of which may be used as part of ongoing sessions with second device(s) 1204. For example, and as shown in FIG. 14, at least some of the slots 1402(1)-1402(4) may be used for transmitting data 1404 (or other information, bits, etc.) between the first device 1202 and one or more active second devices 1204 which have an ongoing session with the first device 1202. However, in various instances, some slots (e.g., slots 1402(5)-1402(8)) may be empty, inactive, or otherwise not in use.

In some embodiments, responsive to transmitting the AC IE 1212 during the round, with the association availability field 812 set to a value indicating availability for additional association(s), the first device 1202 may be configured to remain active for each slot of the round. For example, rather than entering a sleep mode (or dozing, switching to an idle state, etc.), the UWB transceiver 1208 may be configured to remain in an active state for each of the inactive slots (e.g., slots 1402(5)-1402(8)), to receive any association request frames from a potential controlee.

Referring back to FIG. 12, in some instances, the second device 1204(1) may be configured to sense, detect, identify, or otherwise receive the AC IE 1212 from the first device 1202 via the UWB transceiver 1208 of the second device 1204(1). The second device 1204(1) may be configured to receive the AC IE 1212 responsive to detecting the first device 1202 broadcasting the AC IE 1212 (e.g., at the start of a round). As described in greater detail below, the second device 1204(1) may be configured to attempt to establish a session with the first device 1202, according to the AC IE 1212. The second device 1204(1) may attempt to establish the session with the first device 1202 responsive to switching to an active or on state, powering on, responsive to receiving a user input (e.g., to establish the session), etc. The second device 1204(1) may include an AC IE processor 1214. The AC IE processor 1214 may be or include any device, component, element, or hardware designed or configured to parse, analyze, inspect, or otherwise process an AC IE 1212 received from a controller device (e.g., the first device 1202). In some embodiments, the AC IE processor 1214 may be configured to process the AC IE 1212 to determine, detect, or otherwise identify the availability for an association with the controller device. The AC IE processor 1212 may be configured to parse the AC IE 1212 to identify a value provided by the controller device to the association availability field 812. The AC IE processor 1212 may be configured to identify the availability to establish the session with the first device 1202, based on or according to the value (e.g., determine that a session is available to establish based on the value being high or “1”, or may be configured to determine that a session is unavailable to establish based on the value being low or “0”).

The second device 1204(1) may include an association request generator 1216. The association request generator 1216 may be or include any device, component, element, or hardware designed or configured to establish, produce, generate, create, or otherwise configure an association request frame 1218 (referred to generally as an “association request” 1218) for transmission to the first device 1202. The association request generator 1216 may be configured to generate the association request 1218 according to the value provided in the AC IE 1212 by the first device 1202. In this regard, the association request generator 1216 may be configured to generate the association request 1218, responsive to the AC IE 1212 indicating that a session is available for establishing with the first device 1202.

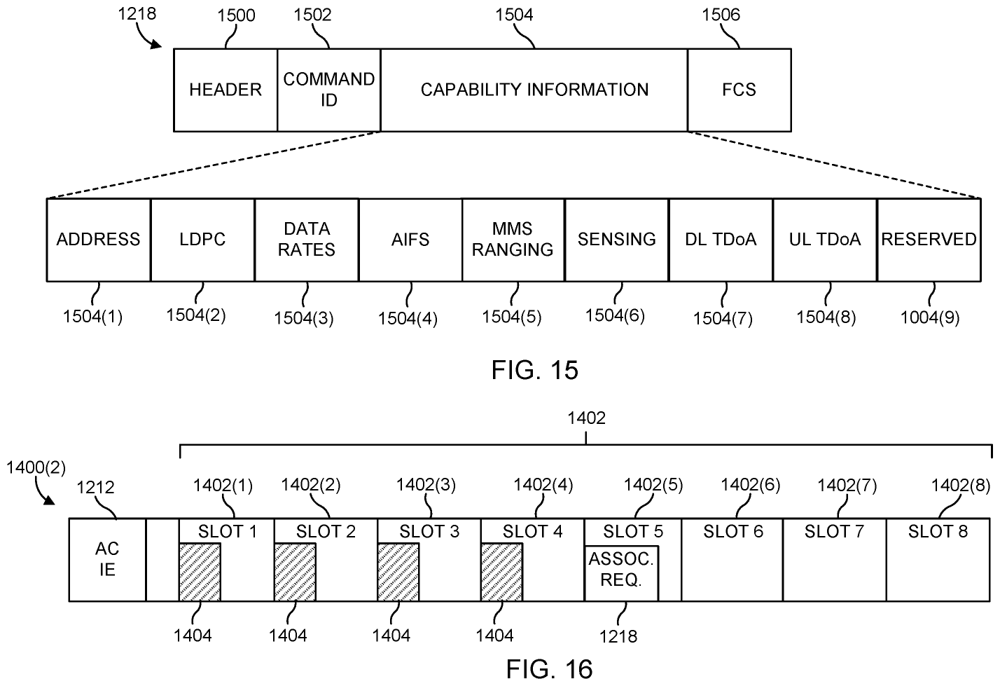

Referring now to FIG. 12 and FIG. 15, the association request frame 1218 may include capability information of the second device 1204(1). In particular, FIG. 15 is a diagram showing an example frame structure of an association request 1218 sent by a controlee (e.g., the second device 1204(1), according to an example implementation of the present disclosure. As shown in FIG. 15, the association request 1218 may include a plurality of fields including a header field 1500, a command ID field 1502, capability information field(s) 1504, and a frame check sequence (FCS) field 1506. The header field 1500 may be or include a field for providing a medium access control (MAC) header for the association request 1218. The command ID field 1502 may be or include a field for providing an identifier which indicates a type of command (e.g., a first identifier indicating the frame is an association request frame, a second identifier indicating the frame is an association response frame, etc.). The FCS field 1506 may include a field for providing a FCS, or any other error-detection code or sequence which may be used to verify the integrity of the association request frame 1218.

The association request 1218 may include a plurality of capability information fields 1504 for providing, indicating, or otherwise representing capabilities of the second device 1204(1). In some embodiments, the capability information fields 1504 may include a first field 1504(1) for providing an address (e.g., a short address), a second field 1504(2) for indicating support for low density parity check (LDPC), a third field 1504(3) for indicating information on data rate(s), a fourth field 1504(4) for indicating an arbitration interframe space (AIFS), a fifth field 1504(5) for indicating a capability for multi-millisecond (MMS) ranging, a sixth field 1504(6) for indicating a capability for UWB sensing, a seventh field 1504(7) for indicating a capability for downlink (DL) time difference of arrival (TDoA), an eight field 1504(8) for indicating a capability for uplink (UL) TDoA, and a reserved field 1504(9) for one or more reserved bits indicating other capabilities of the second device 1204(1). In some embodiments, the association request generator 1216 may be configured to generate, establish, produce, or otherwise provide a short address for the second device 1204. The association request generator 1216 may be configured to generate the short address by assigning a random number or address for the second device 1204 to use during the session with the first device 1202. The association request generator 1216 may be configured to provide the short address in the first field 1504(1).

The association request generator 1216 may be configured to populate the capability information fields 1504 based on or according to resources to be used, executed, or otherwise supported during the session. For instance, the association request generator 1216 may be configured to select or otherwise identify the capabilities to be used for the session based on an application or resource used between the devices 1202, 1204. For example, certain applications or resources may leverage particular capabilities, including, e.g., a voice over IP (VOIP) or other call/video conference resource may leverage data transmission or certain data rate capabilities, a gaming or virtual/augmented reality resource may leverage sensing and ranging capabilities, and so forth. The association request generator 1216 may be configured to populate the capability information fields 1504 based on or according to the particular capabilities leveraged by a resource or application to be executed or supported during the session.

Similarly, the association request generator 1216 may be configured to populate the capability information fields 1504 based on or according to software/hardware configurations of the second device 1204. The association request generator 1216 may be configured to populate the capability information fields 1504 based on particular hardware or software deployed at the second device 1204. For instance, the second device 1204 may or may not support LDPC, may support or use a certain AIFS (such as, e.g., 64 μs, 32 μs, or 16 μs AIFS), may support or request a certain data rate or packet header data rates (e.g., 124.8, 62.4, 31.2, 7.8 Mbps supported). The association request generator 1216 may be configured to populate the capability information fields 1504 based on or according to such information. For example, the association request generator 1216 may be configured to populate the second field 1504(2) with a bit set to high (or “1”) where LDPC is enabled/supported, and conversely set the bit to low (or “0”) where LDPC is not supported. The association request generator 1216 may be configured to populate the third field 1504(3) with a value according to the data rate to be used or supported during the session (e.g., set to low, or “0”, where packet header (PHY) rates−62.4, 31.2, 7.8 Mbps—are supported, or set to high, or “1”, where PHY rates+124.8 Mbps are supported. Similarly, the association request generator 1216 may be configured to populate the fourth field 1504(4) with a value indicating a supported AIFS. The association request generator 1216 may be configured to populate the AIFS field 1504(4) with a value selected from Table 1 below.

TABLE 1
Values for Supported AIFS field

| Supported AIFS | Supported |
|---|---|
| Field Value | AIFS |
| 0 | 64 μs |
| 1 | 64 μs, 32 μs |
| 2 | 64 μs, 32 μs, 16 μs |
| 3 | Reserved |

Referring now to FIG. 12 and FIG. 16, upon generating the association request 1218, the second device 1204 may be configured to determine or otherwise identify a slot in which to provide the association request to the first device 1202. Specifically, FIG. 16 shows an example second round of slots of the first device 1202, during one of which the second device 1204 transmits the association request 1218 to the first device 1202, according to an example implementation of the present disclosure. In some embodiments, the association request generator 1216 may be configured to determine a slot in which to transmit, communicate, send, or otherwise provide the association request 1218 to the first device 1202.

In some embodiments, the association request generator 1216, upon receiving or otherwise identifying the AC IE 1212 in a round which includes an association availability field value indicating availability to establish an association with the first device 1202, may perform a scan of the slots to identify an open or otherwise available slot during the round. For example, the second device 1204 may be configured to perform a scanning process, to identify any unscheduled slot in the round. As shown in FIG. 16 (and as described previously with reference to FIG. 14), slots 1402(5) through 1402(8) may be unscheduled. The second device 1204 may be configured to identify the fifth slot 1402(5) (or any other slot, mini-slot, etc.) in which to communicate, transmit, or otherwise provide the association request 1216 to the first device 1202. The first device 1202, because the UWB transceiver 1208 of the first device 1202 is active for each slot including those which are unscheduled responsive to indicating availability to establish an association in the AC IE 1212, may be configured to receive the association request 1218 in the fifth slot 1402(5) sent by the second device 1204.

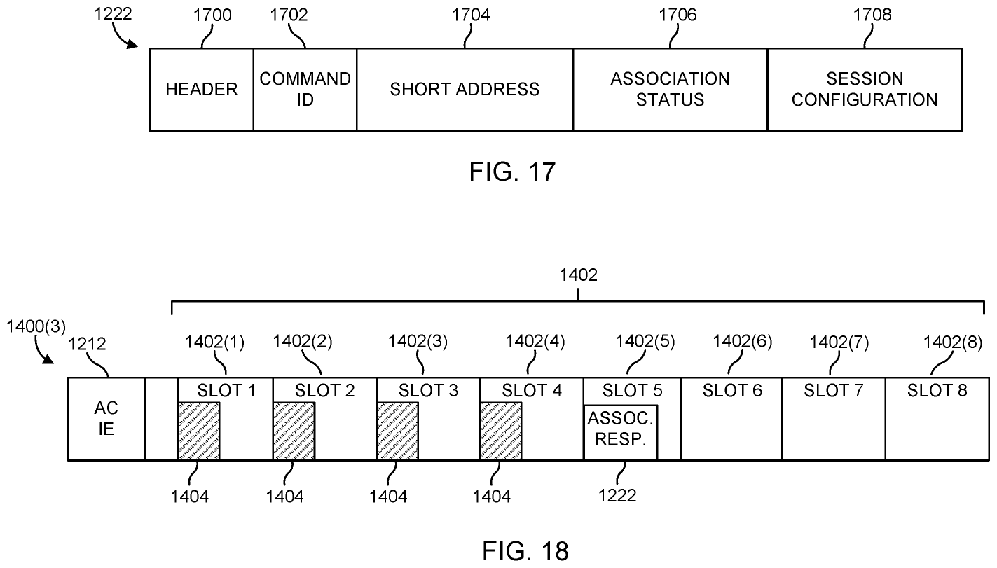

Referring now to FIG. 12 and FIG. 17, the association response generator 1220 of the first device 1202 may be configured to generate an association response 1222, based on or according to the association request 1218. Specifically, FIG. 17 shows an example frame structure of an association response 1222 sent by the controller (e.g., the first device 1202) to the controlee (704), according to an example implementation of the present disclosure. As shown in FIG. 17, the association response 1222 may include a header field 1700, a command ID field 1702, a short address field 1704, an association status field 1706, and a session configuration field 1708. The header field 1700 and command ID field 1702 may be similar to the header field 1500 and command ID field 1502 described above with reference to FIG. 15. The association response generator 1220 may be configured to populate the header field 1700 and command ID field 1702 with a corresponding header and command ID. The association response generator 1220 may be configured to populate the short address field 1704 based on the short address provided in the association request 1218 (e.g., either indicating acceptance or denial of the short address generated by the second device 1204, providing an alternative short address, etc.).

The association response generator 1706 may be configured to populate or otherwise configure the association status field 1706 based on a status of the association request and/or the requested capability information. For example, the association response generator 1706 may be configured to populate or configure the association status field 1706 with a value selected from Table 2 below.

TABLE 2
Values for Association Status Field

| Association | |
|---|---|
| Status | Description |
| 0 | Association successful. |
| 1 | Session at capacity. |
| 2 | Short address duplication. |
| 3 | Capabilities unsupported. |
| 4 | Association denied for other reason. |
| 5-ff | Reserved |

As shown in Table 2, the association response generator 1220 may be configured to indicate a successful association by providing a corresponding value in the association status field 1706 (e.g., “0”), and may indicate an unsuccessful association by providing another corresponding value in the association status field 1706. The association response generator 1220 may be configured to indicate a reason or support for the unsuccessful association by selecting the corresponding value for the association field 1706 (e.g., indicating the session is at capacity by populating the field 1706 with a value of “1”, indicating a duplication of a short address of the second device 1204 by populating the field 1706 with a value of “2”, indicating unsupported capabilities by populating the field 1706 with a value of “3”, etc.).

In some embodiments, where the association response generator 1220 declines or rejects the association because of unsupported capabilities requested by the second device 1204, the association response generator 1220 may be configured to indicate, identify, or otherwise include information relating to which capabilities are unsupported. For example, the association status field 1706 may be an octet, and the association response generator 1220 may be configured to populate the association status field 1706 with values indicating which particular capabilities are unsupported (e.g., using individual bits representing capabilities similar to those shown in the capability information fields 1504 described above with reference to FIG. 15). To the extent additional capability information fields 1504 are added (e.g., via the reserved field 1504(9)), the association response frame 1222 may increase in bit size (e.g., to provide additional fields for accommodating identifying additional capability unsupported fields.

The association response generator 1220 may be configured to populate the session configuration field 1708 with configuration information relating to the session, responsive to successful association. In some embodiments, the association response generator 1220 may be configured to populate the session configuration field 1708 with a value indicating a selected or configured AFIS. The association response generator 1220 may be configured to populate or provide the selected or configured AIFS value based on the value selected by the second device 1204 in the AIFS field 1504(4) of the association request. The association response generator 1220 may be configured to provide the selected AIFs using a corresponding field value from Table 3 below.

TABLE 3
Values for AIFS field
indicating Selected AIFS

| AIFS Field | |
|---|---|
| Value | AIFS |
| 0 | 64 μs |
| 1 | 32 μs |
| 2 | 16 μs |
| 3 | Reserved |

As shown in Table 3, for example, where the AIFS field 1504(4) of the association request 1218 includes a value of “0” indicating an acceptable AIFS value of 64 μs, the association response generator 1220 may be configured to populate the session configuration field 1708 with a value indicating the AIFs of 64 μs (e.g., a AIFS field value of “0”). As another example, where the AIFS field 1504(4) of the association request 1218 includes a value of “3” indicating acceptable AIFS values of 64 μs, 32 μs, or 16 μs, the association response generator 1220 may be configured to populate the session configuration field 1708 with a value indicating any of the selected AIFS.

Referring to FIG. 12 and FIG. 18, once the association response generator 1220 generates or otherwise configures the association response 1222, the first device 1202 may be configured to communicate, transmit, send, or otherwise provide the association response 1222 back to the second device 1204. Specifically, FIG. 18 shows an example third round of slots of the first device 1202, during one of which the first device 1202 transmits the association response 1222 to the second device 1204, according to an example implementation of the present disclosure. In some embodiments, the first device 1202 may be configured to communicate or otherwise transmit the association response 1222 to the second device 1204 in the same slot (e.g., of a subsequent round) in which the first device 1202 received the association request 1218. Continuing the example shown in FIGS. 14, 16, and 18, the first device 1202 may be configured to communicate the association response 1222 in the fifth slot 1402(5), which is the same slot in which the first device 1202 received the association request 1218 (as shown in FIG. 16).

It is noted that, while particular frame formats are illustrated in FIG. 8, FIG. 15, and FIG. 17, it should be understood that the present disclosure is not limited to the particular order or contents of the frame formats. Rather, these formats are intended to be examples of frames which could be used for an AC IE 1212, association request 1218, and association response 1222 in various embodiments of the present disclosure.

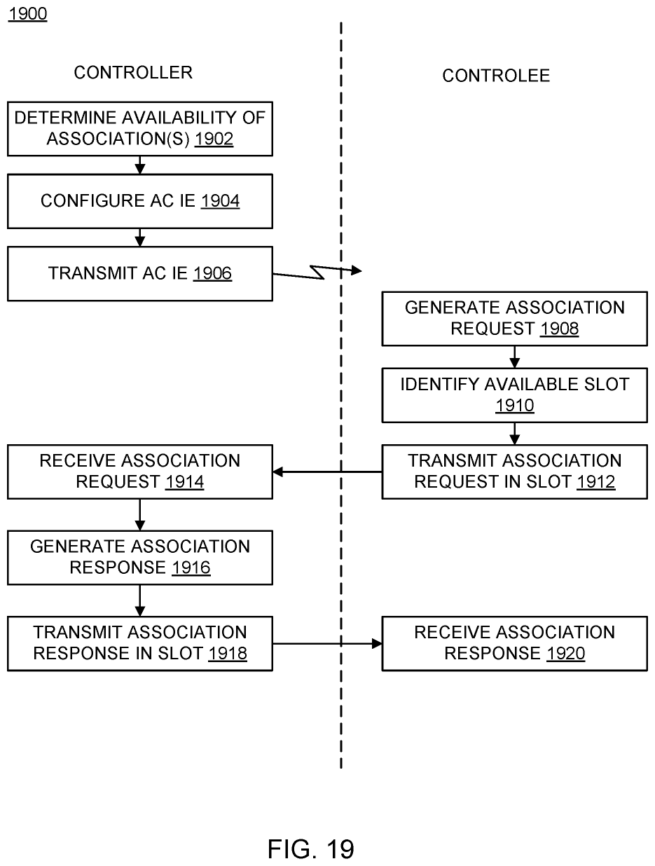

Referring now to FIG. 19, depicted is a flowchart showing an example method 1900 for ultra-wideband in-band discovery, according to an example implementation of the present disclosure. The method 1900 may be performed by various devices, components, or elements described above with reference to FIG. 1-FIG. 18. In some embodiments, some steps or processes of the method 1900 may be performed by one device (such as the first device 1202), and other steps or processes of the method 1900 may be performed by another device (such as the second device 1204). The method is described with reference to a controller and a controlee, though it should be understood that the controller may be a controller device (or the first device), and the controlee may be a controlee device (or the second device).

At step 1902, a controller may determine availability of associations. In some embodiments, the controller may determine an availability of associations with one or more potential controlees. The controller may determine the availability based on current resources used or attributable to ongoing sessions maintained by the controller with existing controlees. The controller may determine the availability responsive to establishing new sessions or associations. The controller may determine the availability responsive to or prior to beginning a new round with existing controlees. The controller may determine the availability prior to generating an application control information element. The controller may determine the availability, to provide such information to potential controlees in an environment of the controller. The controller may determine the availability by applying current resources (e.g., bandwidth, slots, etc.) dedicated to, assigned to, or otherwise attributed to active sessions to a threshold criteria or criterion. The controller may determine the availability based on a comparison of the current resources to the threshold. For example, the controller may determine that additional associations are available based on the current resources satisfying the threshold (e.g., one or more slots are available, available bandwidth, etc.).

At step 1904, the controller may configure an application control (AC) information element (IE). In some embodiments, the controller may configure the AC IE based on or according to the availability of associations determined at step 1902. For example, the AC IE may include various fields for providing control information relating to ongoing sessions. The AC IE may also include at least one field indicating an association availability. The controller may configure the AC IE to indicate or otherwise identify the determined availability for associations by potential controlees with the controller. In other words, the controller may configure the AC IE, which has an association availability field, with a value to indicate the availability of an association with the controller and a potential controlee.

At step 1906, the controller may transmit the AC IE. In some embodiments, the controller may transmit the AC IE at the start of a round as part of ongoing session(s) with other controlees. The controller may transmit the AC IE as a first frame, packet, or element of the round, followed by a plurality of slots corresponding to the round. In some embodiments, for each round, the controller may repeat steps 1902-1906 (e.g., to determine the availability, configure the AC IE, and transmit the AC IE). The controller may transmit the AC IE on a channel for ongoing session(s) with current controlees.

In some instances, a potential controlee may receive the AC IE. The controlee may receive the AC IE by performing a scan of each channel and preamble code, to identify the AC IE transmitted at the beginning of the round by a controller. The controlee may perform the scan responsive to determining to establish an association with the controller. For example, the controlee may determine to attempt establishing the association responsive to the controlee powering on, responsive to receiving a user input to establish a session with the controller, responsive to launching an application or resource which triggers establishing the association, and so forth. The controlee may receive the AC IE during or as part of the scan, responsive to the controller transmitting the AC IE at the beginning of the round. The controlee may parse the AC IE to determine, detect, or otherwise identify a value in the AC IE indicating the availability for an association with the controlee.

At step 1908, a controlee may generate an association request. The controlee may generate the association request, responsive to the ACI IE indicating the availability for an association with the controller. The controlee may generate the association request by populating various fields with values indicating, for instance, capability information, requested configuration settings for the session, and so forth. The capability information may include support for low density parity check (LDPC), a data rate or supported data rates, an arbitration interframe space (AIFS) or available/supported AIFS, support for multi-millisecond (MMS) ranging, support for sensing, support for downlink time difference of arrival (TDoA), and/or support for uplink TDoA. The controlee may generate the association request based on configurations of the controlee and/or based on resource demands/requirements/needs/settings for an application or resource executing on or otherwise supported by the controlee during the session with the controller.

At step 1910, the controlee may identify/determine an available slot. In some embodiments, the controlee may identify an available slot in which to send, communicate, or otherwise transmit the association request to the controller. The controlee may identify the available slot by performing a scan of each of the slots in the round, to identify or otherwise determine an unoccupied or otherwise available slots (e.g., a slot which is currently not in use by a controlee as part of an active session with the controller). The controller may select or otherwise identify the available slot from the identified available slots. For example, the controller may select the available slot as the first available slot, as any available slot, as any sub-slot, etc. At step 1912, the controlee may transmit the association request in the slot. In some embodiments, the controlee may transmit the association request to the controller in the slot selected at step 1910. The controlee may transmit the association request to the controller, to attempt to establish an association with the controller. The controlee may transmit the association request in the available slot of a subsequent round (e.g., subsequent to the round in which the controlee received the AC IE from the controller).

At step 1914, the controller may receive the association request. In some embodiments, the controller may receive the association request from the controlee in an available slot of a round. In some embodiments, according to the AC IE configured at step 1904 and transmitted at step 1906, the controller may remain active for each slot of the round, regardless of whether or not the slot is available or unavailable. The controlee may maintain an active state for each available slot for receipt of any association requests from potential controlees. The controlee may maintain in the active state according to the association availability configured in the AC IE. The controller may receive the association request from the controlee responsive to maintaining in the active state.

At step 1916, the controller may generate an association response. In some embodiments, the controller may generate the association response, based on or according to the association request received at step 1914. The controller may generate the association response to indicate an association status of the association request. Thus, the association response may include an association field including a value which indicates the association status. The association status may include, for example, a successful association, a session at capacity, a rejected short address, etc. The controller may configure the association response based on or according to whether the controller accepts the configuration information provided in the association request (e.g., including the capability information). The controller may configure the association response to indicate whether or not the association was successful. Where the association was unsuccessful, the controller may configure the association response to provide a basis for the unsuccessful association.

At step 1918, the controller may transmit the association response in the slot. In some embodiments, the controller may transmit the association response to the controlee. The controller may transmit the association response in the slot (e.g., of a subsequent round) in which the controlee sent the association request to the controller. The controller may transmit the association response according to the association request. The controller may transmit the association response, to indicate successful or unsuccessful association between the controller and controlee.

At step 1920, the controlee may receive the association response. In some embodiments, the controlee may receive the association response in the same slot (e.g., a subsequent round) in which the controlee sent the association request. In instances where the association response indicates successful association, the controlee may exchange various data/information/packets/etc. with the controller on the session established as part of the association. In this regard, the controller and controlee may establish a session according to the association request and association response. Where the association response indicates an unsuccessful association, in some embodiments, the controlee may reattempt association (e.g., using different configuration details or capability information) with the controller. In some embodiments, the controlee may attempt association with a different controller responsive to the association response indicating an unsuccessful association.

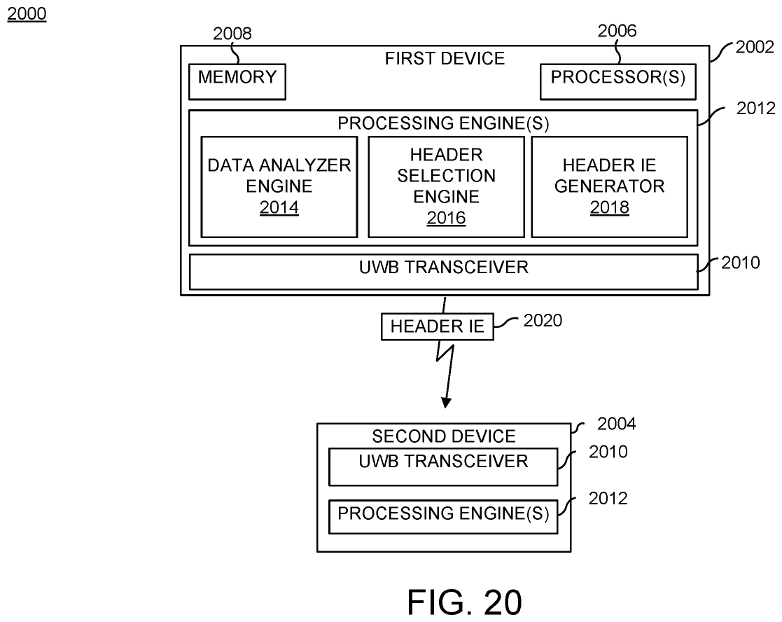

Referring generally to FIG. 20-FIG. 22, various embodiments disclosed herein relate to a header information element (IE) for data communications with a reduced payload size. Some physical layer convergence protocol (PLCP) service data units (PSDU) may have a data frame size which is relatively small, particularly for low latency applications. For example, a PSDU may have nine bytes of medium access control (MAC) overhead due to a header (e.g., seven bits) and footer (two bits). Continuing this example, where a PDSU is used to transmit 18 bits of inertial measurement unit (IMU) data, the PSDU may have an overall size of 27 bits including the MAC overhead. Additionally, the PSDU size of control messages with legacy IEs may be comparatively larger than the size of the PSDU payload. For example, the control message may have an 11 bit MAC overhead (e.g., seven byte MAC header, two bit MAC footer, and two bit nested payload IE header), a 15 bit advancing ranging control (ARC) IE for control parameters, and a 5+3N ranging device management (RDM) IE for scheduling N slots. Thus, the total number of bytes of the control message may include 31+3N bits (e.g., 58 bits where the number of slots, N, is 9). Due to various regulatory policies (which may limit the transmit (TX) power per one ms), long control messages may need to be sent with lower transmit power than short data frames. As such, long control messages (e.g., having 58 bits in the example above) could become a bottleneck.

According to the systems and methods described herein, a device may use a compressed IE for reduced payload data communications. In various embodiments, the device may determine, estimate, or otherwise quantify a payload size for data communications. The device may determine the payload size based on the particular type of data (e.g., IMU data, sensor data, control data, etc.). The device may determine the payload size based on the application or resource accessed via the device, based on the source of the data, etc. The device may compare the payload size to a threshold, to determine whether the payload size satisfies a threshold criteria. Where the payload size satisfies the threshold criteria (e.g., is less than and/or equal to the threshold value), the device may use a compressed IE. On the other hand, where the payload size does not satisfy the threshold criteria, the device may use a decompressed (or uncompressed) IE. According to the systems and methods described herein, reducing the size of the IE for smaller payloads can result in decreased latency and reduced bottlenecks, thereby improving/increasing user experience and throughput.

Referring now to FIG. 20, depicted is a block diagram of a system 2000 for communicating compressed header information elements, according to an example implementation of the present disclosure. The system 2000 may include a first device 2002 and a second device 2004. The first device 2002 may be similar to the first devices described above with reference to FIG. 1-FIG. 19. The second device 2004 may be similar to the second/peripheral devices described above with reference to FIG. 1-FIG. 19. As described in greater detail below, the first device 2002 may be configured to generate a header information element (IE) for a data communication, where the header IE has a header type selected from a condensed header IE and a full header IE. The first device 2002 may be configured to communicate, send, transmit, or otherwise provide the header IE to the second device 2004.

The first device 2002 (and second device 2004) may include one or more processor(s) 2006 and memory 2008. The processor(s) 2006 and memory 2008 may be similar, respectively, to the processor(s) 118/170 or processing units 616 and storage 618 described above with reference to FIG. 1-FIG. 6. The first device 2002 and second device 2004 may include respective ultra-wideband (UWB) transceivers 2010 and processing engine(s) 2012. The UWB transceivers 2010 may be similar to the UWB transceivers 710, 1210 described above, and the processing engine(s) 2012 may be similar to the processing engine(s) 312, 712, 1212, described above. The processing engine(s) 2012 may be or include any device, component, element, or hardware designed or configured to perform functions corresponding thereto. The processing engine(s) 2012 may include a data analyzer engine 2014, a header selection engine 2016, and a header IE generator 2018. While these processing engines 2012 are shown and described, it is noted that, in various embodiments, the processing engines 2012 described herein may be combined into a single processing engine 2012, and/or the processing engines 2012 may be separated into sub-processing engines 2012.

The first device 2002 may include a data analyzer engine 2014. The data analyzer engine 2014 may be or include any device, component, element, or hardware designed or configured to analyze, inspect, or otherwise identify various characteristics/traits/metrics corresponding to data communications to be sent by the first device 2002. In some embodiments, the data analyzer engine 2014 may be configured to identify metrics corresponding to a data packet to be sent from the first device 2002 to the second device 2004. For example, the metrics may be or include a protocol data unit (PDU) size or other data size. The data analyzer engine 2014 may be configured to determine the data size of the data communication to be included in a body/payload of the data communication. In some embodiments, the data analyzer engine 2014 may be configured to determine the data size, by identifying a quantity/amount of data pulled from a buffer for inclusion in a data packet (or data communication).

In some embodiments, the data analyzer engine 2014 may be configured to determine the data size based on or according to an application/application type/traffic type for the data to be included in the data communication. For example, the data analyzer engine 2014 may be configured to determine the source of the traffic to be sent to the second device 2004 (e.g., the originating application or resource of the first device 2002). The data analyzer engine 2014 may be configured to determine an application type or traffic type for the traffic, based on the source (e.g., voice/audio traffic for a voice over internet protocol (VOIP) application, live video for a video conferencing application, etc.). The data analyzer engine 2014 may be configured to determine the data size based on the application or traffic type for the traffic (e.g., where a particular application type or traffic type has a predetermined data size to be included in a PDU packet or other data communication/transmission).

The first device 2002 may include a header selection engine 2016. The header selection engine 2016 may be or include any device, component, element, or hardware designed or configured to determine, identify, choose, or otherwise select a header type to be used for generating a header information element (IE). The header selection engine 2016 may be configured to select the header type based on or according to the metric(s) determined by the data analyzer 2014. For example, the header selection engine 2016 may be configured to select the header type based on the data size for the data communication determined by the data analyzer engine 2014.

In some embodiments, the header selection engine 2016 may be configured to select the header type from a first header IE and a second header IE. The first header IE may be a full header IE, and the second header IE may be an abbreviated, compressed, reduced, shortened, or otherwise condensed header (e.g., with respect to the full header IE). In this regard, the second header IE may include fewer fields, fewer bits, fewer bytes, etc. than the first header IE. The header selection engine 2016 may be configured to select the header type, based on a comparison of the metric(s) (e.g., from the data analyzer engine 2014) to one or more thresholds.

The header selection engine 2016 may be configured to select the header type, according to the metric(s) satisfying a threshold criterion (e.g., a data size being greater than or equal to a threshold data size). In some embodiments, the header selection engine 2016 may be configured to select the first header IE as the header type responsive to the metric(s) satisfying the threshold criterion. For example, the header selection engine 2016 may be configured to select the first header IE as the header type responsive to the data size being greater than or equal to the threshold. In this regard, the header selection engine 2016 may be configured to select a full header IE to be used for a data communication, responsive to the data size of the payload to be included in the data communication being greater than (or equal to) the threshold. The header selection engine 2016 may be configured to select the second header IE as the header type, responsive to the metric(s) satisfying a different threshold criterion. For example, the header selection engine 2016 may be configured to select the second header IE as the header type responsive to the data size being less than or equal to the threshold. In this regard, the header selection engine 2016 may be configured to select a compressed header IE to be used for a data communication, responsive to the data size of the payload to be included in the data communication being less than (or equal to) the threshold.

The first device 2002 may include a header IE generator 2018. The header IE generator 2018 may be or include any device, component, element, or hardware designed or configured to configure, produce, create, establish, or otherwise generate a header IE 2020 for a data communication. The header IE generator 2018 may be configured to generate the header IE 2020, based on or according to the selected header type (e.g., determined or otherwise selected by the header selection engine 2016). The header IE generator 2018 may be configured to generate the header IE 2020 using configuration information for the session established between the first device 2002 and second device 2004, and according to the selected header type.

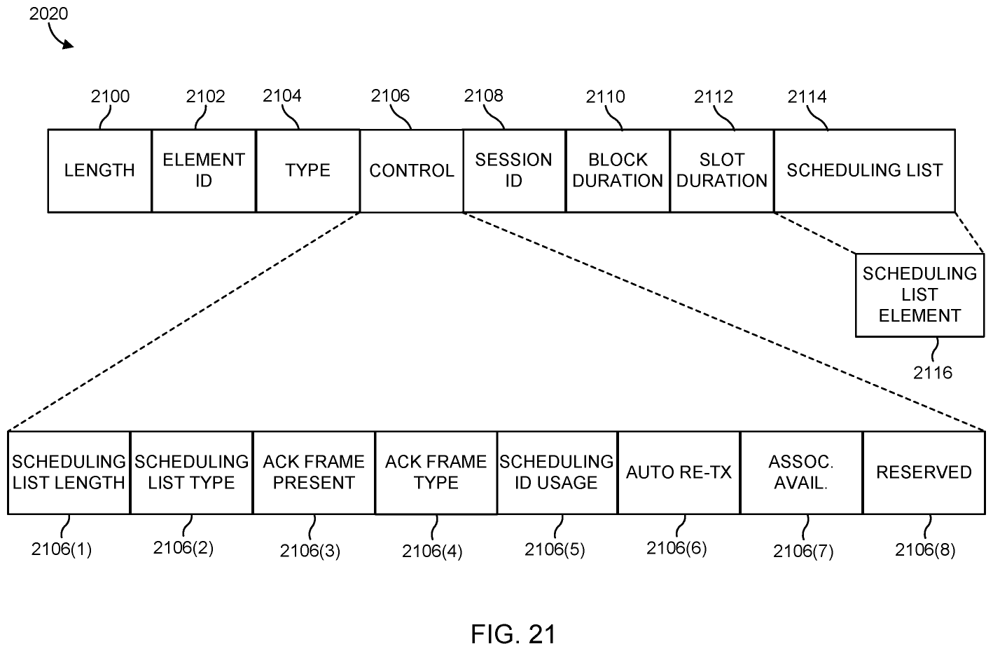

Referring now to FIG. 20 and FIG. 21, the condensed header IE 2020 may include a plurality of fields populated by the header IE generator 2018. Specifically, FIG. 21 shows a diagram of a condensed header IE 2020, according to an example implementation of the present disclosure. The header IE generator 2018 may be configured to populate the fields of the header IE 2020, based on or according to configuration information for the session determined by the header IE generator 2018. The condensed header IE 2020 may include a length field 2100, an element identifier (ID) field 2102, a header type field 2104, a control field 2106 (e.g., including a plurality of sub-fields 2106(1)-2106(8)), a session identifier field 2108, a block duration field 2110, a slot duration field 2112, and a scheduling list field 2114.

The header IE generator 2018 may configure or provide information/bits to the length field 2100, to indicate or otherwise identify a length (e.g., in bits, bytes, etc.) of the header IE 2020. For example, the length field 2100 may include 7 bits (e.g., bits 0-6) to indicate or otherwise identify the length of the header IE 2020. The header IE generator 2018 may configure or provide information/bits to the element ID field 2102, to indicate or otherwise identify an identifier for the header IE 2020. For example, the length field 2100 may include 8 bits (e.g., bits 7-14) to indicate or otherwise identify the identifier for the header IE 2020. The header IE generator 2018 may configure or provide information/bits to the type field 2104, to indicate or otherwise identify a type of frame corresponding to the data communication (e.g., a beacon frame, data frame, acknowledgement frame, MAC command, etc.). The header IE generator 2018 may configure or provide information/bits to session ID field 2108, to indicate or otherwise identify an identifier for the session between the first device 2002 and second device 2004. For example, the length field 2100 may include four octets to indicate or otherwise identify the session identifier in the header IE 2020. The header IE generator 2018 may configure or provide information/bits to block duration and slot duration fields 2110, 2112, to indicate or otherwise identify the duration of the block and slots to be used during the session between the first device 2002 and second device 2004. The scheduling list field 2114 may be used to provide a scheduling list value 2116, as described in greater detail below.

The control field 2106 may include a plurality of sub-fields for providing various control information relating to the header IE 2020. For example, the control field 2106 may include a scheduling list length sub-field 2106(1), a scheduling list type sub-field 2106(2), an acknowledge frame present sub-field 2106(3), an acknowledgement frame type sub-field 2106(4), a scheduling identifier usage sub-field 2106(5), an automatic retransmission sub-field 2106(6), an association availability sub-field 2106(7), and a reserved sub-field 2106(8).

The header IE generator 2018 may be configured to provide information/bits to the acknowledgement frame present and acknowledgement frame type sub-fields 2106(3), 2106(4), to indicate or otherwise identify whether an acknowledgement frame is present in the data communication and the type of acknowledgement, respectively. The header IE generator 2018 may be configured to provide information/bits to the scheduling ID usage sub-field 2106(5), to indicate or otherwise identify whether an identifier (e.g., rather than a sender and receiver address) for scheduling is to be used during the session/in the data communication. The header IE generator 2018 may be configured to provide information/bits to the automatic retransmission sub-field 2106(6), to indicate or otherwise identify whether automatic retransmissions are to be sent by the devices 2002, 2004. The association availability sub-field 2106(7) may be similar to the association availability field 1312 described above with respect to FIG. 12-FIG. 19.

The header IE generator 2018 may configure or provide information/bits to the scheduling list length sub-field 2106(1), to indicate or otherwise identify a length of the scheduling list element 2116. For example, the scheduling list length sub-field 2106(1) may include values indicating a number of bits/bytes/octets/etc. of the scheduling list element 2116. The header IE generator 2018 may configure or provide information/bits to the scheduling list type sub-field 2106(2), to indicate or otherwise identify a type of the scheduling list element 2116. For example, the scheduling list element 2116 may be or include various types of scheduling list elements (including those described above with reference to FIG. 7-FIG. 11, and/or those described in greater detail below). The header IE generator 2018 may be configured to provide bits/information to the scheduling list type sub-field 2106(2), to indicate the type of scheduling list element used in the header IE 2020.

In some embodiments, the header IE generator 2018 may be configured to populate the scheduling list type sub-field 2106(2) with a value according to the particular scheduling method used for the scheduling list element 2116. The header IE generator 2018 may be configured to populate the scheduling list type sub-field 2106(2) with a value selected from Table 4 below.

TABLE 4
Scheduling List Type Values for
Corresponding Scheduling Methods

| Value | Scheduling Method |
|---|---|
| 0 | Per-slot scheduling with slot index |
| 1 | Per-slot scheduling without slot index |
| 2 | Bitmap-based scheduling |
| 3 | Periodic scheduling. |

The header IE generator 2018 may be configured to populate the scheduling list type sub-field with a value of “0”, where each slot is to be scheduled to different controlees. In this example, the scheduling list element 2116 may have a format including an address or identifier corresponding to the controlee (or session identifier, or other identifier/address indicating the corresponding session in which the slot is being scheduled), and a slot index (e.g., indicating which slot specified in the slot index field is being assigned to the device corresponding to the address or identifier). The header IE generator 2018 may be configured to populate the scheduling list type sub-field with a value of “1”, where each slot is scheduled to a different controlee but no empty slots are present between scheduled slots (e.g., slots are to be scheduled consecutively). In this example, the scheduling list element 2116 may have a format which includes the address or identifier corresponding to the controlee, but forego the slot index. Continuing this example, each N-th scheduling list element may schedule the corresponding N-th slot to the specified device. For instance, if the header includes two scheduling list elements, the first element may assign the first slot to the device specified in the first element, and the second element may assign the second slot to the device specified in the second element. The header IE generator 2018 may be configured to populate the value of “2”, where each slot is to be scheduled according to a bitmap. Bitmap slot scheduling is described above with reference to FIG. 10C. The header IE generator 2018 may be configured to populate the value of “3”, where each slot is to be scheduled according to a periodic slot scheduling. Periodic slot scheduling is described above with reference to FIG. 10B.

While the values shown in Table 4 are described, it is noted that the present disclosure is not limited to the particular values and their associated scheduling methods. Rather, certain values may be associated with different scheduling methods, and other values may be used or reserved.

The full header IE may include fields similar to those shown in FIG. 21, in addition to other fields which are not present in the condensed header IE 2020 or fields which provide other information. For example, the full header IE may include a round duration field, whereas the condensed header IE 2020 may omit the round duration field. Additionally, some fields of the condensed header IE 2020 may indicate or provide different information than corresponding fields of the full header IE. For example, the condensed header IE 2020 and full header IE may both include the block duration field 2110. However, the block duration field of the full header IE may indicate a number of ranging rounds (e.g., in a block), whereas the block duration field 2110 of the condensed header IE 2020 may indicate a number of slots (in a block). Such implementations may reduce a size of the block duration field 2110 in the condensed header IE 2020 relative to the full header IE, by changing the unit of the field from RSTU to number of slots.

Referring back to FIG. 20, once the header IE generator 2018 configures the header IE 2020, the UWB transceiver 2010 may be configured to communicate, transmit, send, or otherwise provide the header IE 2020 to the second device 2004. The UWB transceiver 2010 may be configured to transmit the header IE 2020 to the second device 2004 together with the corresponding data communication. For example, the UWB transceiver 2010 may be configured to transmit the header IE 2020, as the header for the PSDU analyzed by the data analyzer engine 2014 to determine the corresponding metrics (e.g., and also used by the header selection engine 2016 to select the corresponding header type). In this regard, the UWB transceiver 2010 may be configured to transmit condensed header IEs 2020 for data communications involving a data size which is less than (or equal to) a threshold data size, and may be configured to transmit full header IEs for data communications involving a data size which is greater than (or equal to) the threshold data size. Such implementations may reduce bottlenecks and latency caused by using large (or full) header IEs for data communications which do not have at least a threshold data size.

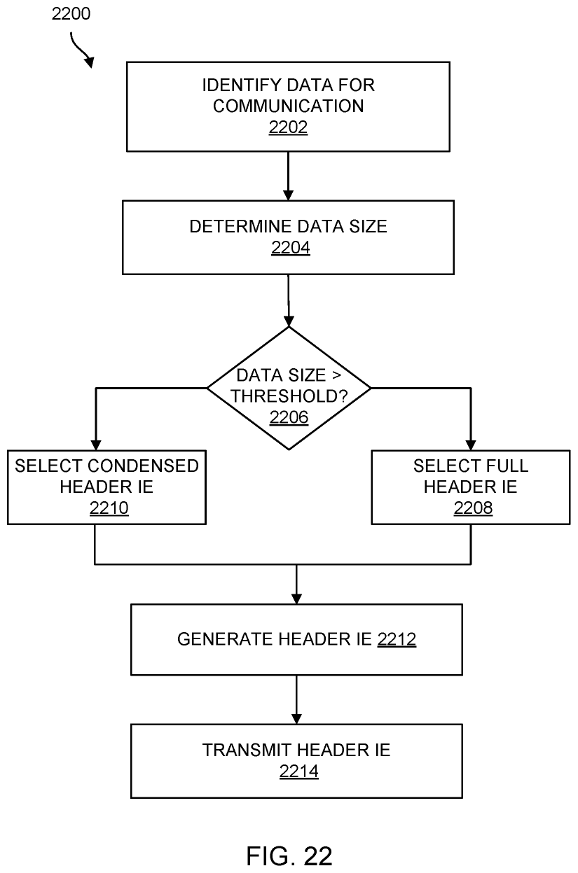

Referring now to FIG. 22, depicted is a flow chart showing an example method 2200 of header information elements for data communications, according to an example implementation of the present disclosure. The method 2200 may be performed by the devices, components, or hardware described above with reference to FIG. 1-FIG. 21. In some embodiments, the method 2200 may be performed by the first device 2002 (e.g., of FIG. 20). In some embodiments, the method 2200 may be performed by the UWB transceiver 2010 of the first device 2002. In this regard, and in various embodiments, the method 2200 may be executed or performed by different layers of the device and by corresponding components or hardware of the device. As a brief overview, at step 2202, a device may identify data for communication. At step 2204, the device may determine a data size. At step 2206, the device may determine whether the data size satisfies a threshold or threshold criteria. At step 2208, the device may select a full header IE. At step 2210, the device may select a condensed header IE. At step 2212, the device may generate a header IE. At step 2214, the device may transmit the header IE.

At step 2202, a device may identify data for communication. In some embodiments, a first device may identify data for including in a PDU payload for transmission to a second device. The first device may identify the data, responsive to the data being queued for transmission to the second device (e.g., by an application or resource of the first device which generated the data). At step 2204, the device may determine a data size. In some embodiments, the first device may determine the data size of the data identified at step 2202. The first device may determine the data size of the data to be communicated in a data communication (e.g., a PDU payload). The first device may determine the data size of the payload of the data communication. The first device may determine the data size prior to generating the PDU or other data packet. In this regard, the first device may determine the data size of the data identified at step 2202, prior to generating a packet which includes the data identified at step 2202.

At step 2206, the device may determine whether the data size satisfies a threshold or threshold criteria. In some embodiments, the device may determine whether the data size identified at step 2204 is greater than or less than a predetermined threshold. The device may compare the data size identified at step 2204 to the threshold. The threshold may be set by a standard, defined for certain applications or use cases, etc. The device may determine whether the data size satisfies a threshold criterion, based on the comparison. For example, where the data size is greater than (or greater than or equal to) the threshold, the data size may satisfy the threshold criterion and the method 2200 may proceed to step 2208. On the other hand, where the data size is less than (or less than or equal to) the threshold, the data size may satisfy a different threshold criterion and the method 2200 may proceed to step 2210.

At step 2208, the device may select a full header IE. In some embodiments, the device may select the full header IE as a type of header IE used for generating a header IE for the data communication. The device may select the full header IE as the type, according to determining that the data size (e.g., identified at step 2204) is greater than the threshold. At step 2210, the device may select a condensed header IE. In some embodiments, the device may select the condensed header IE as the type of header IE used for generating a header IE for the data communication. The device may select the condensed header IE as the type, according to determining that the data size (e.g., identified at step 2204) is less than the threshold. In this regard, the device may select the type of header IE to use for generating the header IE, according to the data size. The device may select the condensed header IE in instances where the data size of the data communication is less than a threshold data size. The device may select the full header IE in instances where the data size of the data communication is greater than a threshold data size.

At step 2212, the device may generate a header IE. In some embodiments, the device may generate a header IE for the data communication. The device may generate the header IE according to the selected type of header IE to be used for generating the header IE. The device may generate the header IE to have a format according to the selected header IE type selected at steps 2208/2210. In instances where the device, at step 2210, selects the condensed header IE as the type of header IE for generating the header IE, the device may configure or otherwise generate the header IE to have a format similar to the format shown in FIG. 21. In instances where, at step 2208, the device selects the full header IE as the type of header IE for generating the header IE, the device may configure or otherwise generate the header IE to have a format including at least some of the fields shown in the header IE of FIG. 21 as well as one or more additional fields. In this regard, a header IE having the condensed header IE type may have fewer bits/bytes/etc. than a header IE having the full header IE type.

At step 2214, the device may transmit the header IE. In some embodiments, the device may transmit the header IE to the second device. The device may transmit the header IE to the second device, responsive to generating the header IE at step 2212. The device may transmit the header IE together with the data communication. The device may transmit the header IE at a start of a ranging block. In this regard, the device may transmit the header IE at, for instance, a similar point in time (or together with) the application control IE 1212 shown in FIG. 14. In some embodiments, the device may transmit the header IE via the UWB transceiver to the second device.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
generating, by a first ultra-wideband (UWB) device, a header information element (IE) for a data communication, the header IE having a header type selected from a condensed header IE and a full header IE; and
transmitting, by the first UWB device, the header IE to a second UWB device.

2. The method of claim 1, wherein the condensed header IE has fewer bits than the full header IE.

3. The method of claim 2, wherein the full header IE comprises a block duration field indicating a number of ranging rounds and a round duration field, and wherein the condensed header field comprises a block duration field indicating a number of slots and omits a round duration field.

4. The method of claim 1, wherein transmitting the header IE to the second UWB device comprises transmitting, by the first UWB device, at a start of a ranging block, the header IE to the second wireless communication device.

5. The method of claim 1, wherein the condensed header IE comprises a scheduling list length field and a scheduling list type field.

6. The method of claim 5, wherein the scheduling list type field has a value selected from a first value indicating a per-slot scheduling with a slot index, a second value indicating a per-slot scheduling without a slot index, a third value indicating a bitmap-based scheduling, and a fourth value indicating a periodic scheduling.

7. The method of claim 1, further comprising:
determining, by the first UWB device, a data size of the data communication; and
selecting, by the first UWB device, the type of header IE for the data communication according to the data size.

8. The method of claim 7, wherein selecting the type of header IE for the data communication comprises:
selecting, by the first UWB device, the header type according to a comparison of the data size of the data communication to a threshold.

9. The method of claim 8, wherein the first UWB device selects the condensed header IE responsive to the data size being less than the threshold.

10. A first device, comprising:
an ultra-wideband (UWB) transceiver; and
one or more processors configured to:
generate a header information element (IE) for a data communication, the header IE having a header type selected from a condensed header IE and a full header IE; and
transmit, via the UWB transceiver, the header IE to a second device.

11. The first device of claim 10, wherein the condensed header IE has fewer bits than the full header IE.

12. The first device of claim 11, wherein the full header IE comprises a block duration field indicating a number of ranging rounds and a round duration field, and wherein the condensed header field comprises a block duration field indicating a number of slots and omits a round duration field.

13. The first device of claim 10, wherein the one or more processors are configured to transmit, at a start of a ranging block, the header IE to the second wireless communication device.

14. The first device of claim 10, wherein the condensed header IE comprises a scheduling list length field and a scheduling list type field.

15. The first device of claim 14, wherein the scheduling list type field has a value selected from a first value indicating a per-slot scheduling with a slot index, a second value indicating a per-slot scheduling without a slot index, a third value indicating a bitmap-based scheduling, and a fourth value indicating a periodic scheduling.

16. The first device of claim 10, wherein the one or more processors are configured to:
determine a data size of the data communication; and
select the type of header IE for the data communication according to the data size.

17. The first device of claim 16, wherein the one or more processors are configured to select the header type according to a comparison of the data size of the data communication to a threshold.

18. The first device of claim 17, wherein the one or more processors select the condensed header IE responsive to the data size being less than the threshold.

19. A wireless communication device, comprising:
an ultra-wideband (UWB) transceiver configured to:
generate a header information element (IE) for a data communication, the header IE having a header type selected from a condensed header IE and a full header IE; and
transmit the header IE to a second device.

20. The wireless communication device of claim 19, wherein the UWB transceiver is configured to:
determine a data size of the data communication;
compare the data size to a threshold; and
select the type of header IE for the data communication according to the comparison, wherein the UWB transceiver selects the condensed header IE responsive to the data size being less than the threshold.
